(19) United States
(12) Patent Application Publication
(10) Pub. No.: US 2002/0161690 A1
(43) Pub. Date: Oct. 31, 2002

(54) System, medium and method for trading fixed income securities

(75) Inventors: Peter J. McCarthy, New York, NY (US); Kevin Ingram, Jersey City, NJ (US)

Correspondence Address: Hale and Dorr LLP, The Willard Office Building, 1455 Pennsylvania Ave, NW, Washington, DC, 20004, US

(73) Assignee: TruMarkets, Inc., New York, NY (US)

(21) Appl. No.: 09/809,429

(22) Filed: Mar. 16, 2001

(51) Int. Cl. G06F 17/60

(52) U.S. Cl. 705/37

(57) ABSTRACT

A system, method and medium for performing electronic fixed income trading that allows users to specify and/or control price and/or time limits associated with potential trades while preserving buyer and seller anonymity. According to at least some of the embodiments of the present invention, a pricing module receives financial information from at least one financial data provider, and transmits the data to one or more trading entities. Purchase and/or sell offers are transmitted to a trading module, and can be defined according to any of a plurality of pricing methods. Depending on the user specified parameters that comprise the offer, the system can automatically place the user into the market, or automatically take the user out of the market. Once a trade is executed, a clearing module monitors and records the transactions executed in clearing the trade.

### BACKGROUND OF THE INVENTION

1. Field of the Invention

The present invention relates generally to electronic fixed income trading and, more particularly, to a fixed income trading system and method that allows users to specify and/or control price and/or time limits associated with potential trades while preserving buyer and seller anonymity.

2. Background Description

The fixed income (i.e., bond) market consists of approximately $500 billion in daily trading activity. Most individual bonds are bought and sold in the over-the-counter (OTC) market, which comprises hundreds of securities firms and banks that trade bonds by phone or electronically. Some firms and banks act as dealers who keep an inventory of bonds and buy and sell these bonds for their own account; others act as agent and buy from or sell to other dealers in response to specific requests on behalf of customers.

Although electronic trading systems have gained in popularity in recent years, many still remain relatively simple systems that enable a user to, for example, buy or sell a security at a predetermined price. Such systems therefore may not provide buyers and sellers with access to a wide range of securities listed by a plurality of data providers, or provide users with the ability to optionally search the live securities market based upon predefined criteria. Such systems also may not enable buyers and sellers to anonymously conduct trades directly with each other, or provide features that automatically place a buyer and/or seller into or out of the active market based upon predefined parameters. There is therefore a need for a fixed income securities trading system that provides users with at least the aforementioned features and advantages.

### SUMMARY OF THE INVENTION

It is a feature and advantage of the present invention to allow users to specify and/or control criteria such as price and/or transaction eligibility time limits, thereby automatically placing buyers/sellers into/out of the live market when such prespecified buyer/seller criteria are satisfied.

It is another feature and advantage of the present invention to allow users to specify auction rules and/or conditions associated with the auctioning of a security.

It is still another feature and advantage of the present invention to allow users to view, search and/or buy/sell fixed income securities on a substantially real time basis.

It is yet another feature and advantage of the present invention to provide a plurality of analytical tools that enable traders to explore current fixed income market conditions from each or any of a plurality of data providers.

It is another feature and advantage of the present invention to allow buyers and sellers to conduct fixed income trades directly with each other.

It is another feature and advantage of the invention to provide an electronic exchange that can operate over a private and/or secure network.

It is another feature and advantage of the present invention to allow buyers and sellers to conduct transactions anonymously, thereby concealing the individual's identity, trading patterns, history, market reputation, etc.

These and other objectsfeatures of the present invention are realized in a fixed income security trading system, method and medium utilizing, in at least some embodiments of the present invention, a private, secure network. A pricing module receives real time or substantially real time financial information, preferably from a plurality of financial data providers. The pricing module can transmit at least a portion of the financial information to one or more trading entities each having one or more trading stations. Trading entities can also query the pricing module for securities that satisfy one or more user specified search criteria, and formulate purchase and/or sell orders that can be transmitted to a trading module. Purchase and/or sell orders may be defined according to any of a plurality of pricing methods. Depending on the user specified parameters that comprise the order, the system can automatically place the user into the live securities market, or automatically remove the user from the live securities market. Once a trade is executed, a clearing module monitors and records the transactions executed in clearing the trade.

Before explaining at least some embodiments of the invention in detail, it is to be understood that the invention is not limited in its application to the details of construction and to the arrangements of the components set forth in the following description or illustrated in the drawings. The invention is capable of other embodiments and of being practiced and carried out in various ways.

### BRIEF DESCRIPTION OF THE DRAWINGS

The Detailed Description including the description of a preferred structure as embodying features of the invention will be best understood when read in reference to the accompanying figures wherein:

FIG. 1 is an exemplary embodiment of the system architecture according to the present invention;

FIG. 2 is an exemplary high level flow diagram of the method according to the present invention;

FIG. 3 is an exemplary screen shot of a user account summary;

FIG. 4 is an exemplary screen shot of a user portfolio;

FIG. 5 is an exemplary screen shot that allows a user to edit the details of a portfolio line;

FIG. 6 is an exemplary flow diagram showing the selection process of various pricing methods;

FIG. 7 is an exemplary screen shot of flat pricing;

FIG. 8 is an exemplary screen shot of duration pricing;

FIG. 9 is an exemplary screen shot of spread pricing;

FIG. 10 is an exemplary screen shot that allows a user to search for securities based on one or more user-specified criteria and/or parameters;

FIG. 11 shows an exemplary screen shot of live market activity that match search filter criteria;

FIGS. 12a and 12b show the relationship between auction creation, broadcast, and execution for public and private auctions, respectively;

FIG. 13 is an exemplary flowchart of the auction creation process;

FIG. 14 is an exemplary screen shot that enables users to create an auction with auction bid list items;

FIG. 15 is an exemplary screen shot that enables users to monitor auction activity and configure bids against broadcast bid list items;

FIG. 16 is an exemplary screen shot that allows users to edit, delete, cancel, place and/or privately price auction bids;

FIG. 17 is an exemplary screen shot that allows users to create, edit and/or view an auction bid configured to participate in an auction;

FIG. 18 is an exemplary flow chart of the match process for the live market;

FIG. 19 is an exemplary flow chart of the match process for an auction;

FIG. 20 is an exemplary flow diagram of an overall business workflow of the present invention;

FIG. 21 is an exemplary flow diagram of the overall trading process;

FIG. 22 is an exemplary flow diagram of exception processing within the clearing process;

FIG. 23 illustrates one example of a central processing unit for implementing a computer process in accordance with a computer implemented stand-alone embodiment of the present invention;

FIG. 24 illustrates one example of a block diagram of internal hardware of the central processing unit of FIG. 24; and

FIG. 25 is an illustrative computer-readable medium upon which computer instructions can be embodied.

### DETAILED DESCRIPTION OF A PREFERRED EMBODIMENT OF THE INVENTION

### System Architecture

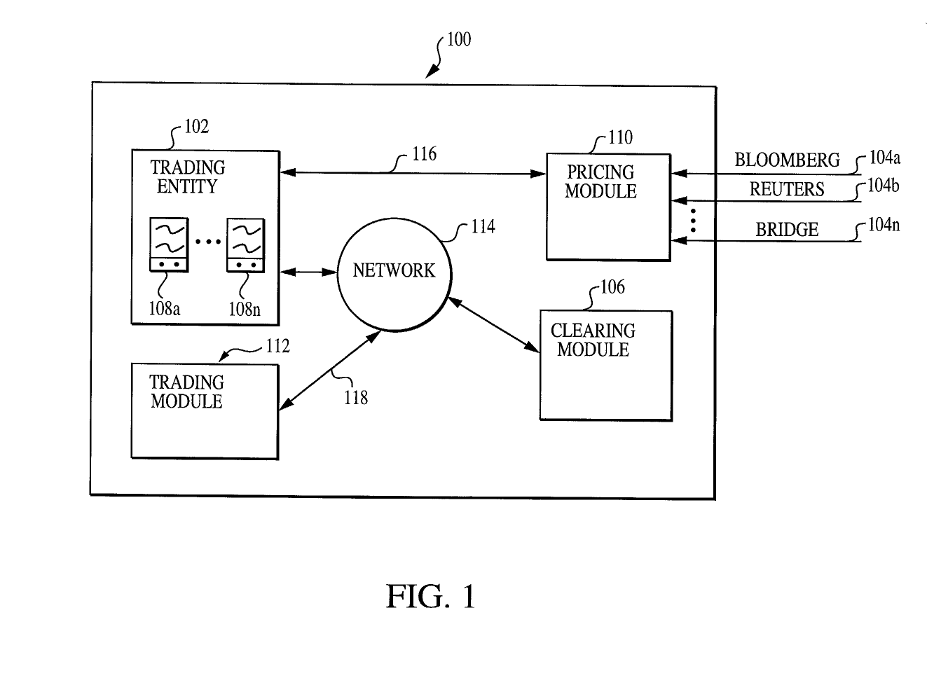

As shown in FIG. 1, the system architecture of at least some embodiments of the present invention contemplate that there are four different entities/types of users that interact with a fixed income trading system 100 via an associated network 114: clearing module 106, trading module 112, trading entity 102, and pricing module 110. The pricing module 110 receives fixed income security data from one or more third party data sources/providers (e.g., Bloomberg, Reuters and/or Bridge, etc.), via data lines/connections 104a, 104b, 104c, respectively. More than one data line can also be provided for each of the data providers. In accordance with at least some embodiments of the present invention, real time data or near real time data pertaining to, for example, the prepayment speed of a security can be used to discount security cash flows to determine the price of a security when given, for example, data pertaining to the security coupon, maturity, and cash flow. Specifically, as will be appreciated by those skilled in the art of fixed income securities, a yield on a fixed income security is required to obtain the current security price. Using the yield, cash flows can be generated based upon, for example, prepayment assumptions, coupon maturity, etc. The generated cash flows are then discounted to the present value in order to ascertain the current price of a given security. In order to calculate the prices, two types of data are used: (i) the real time data (as discussed above), and (ii) referential or indicative data, which include security specific parameters such as, for example, coupon, maturity, and factor. This information, with user input including market assumptions such as, for example, prepayment rate, are used to generate a cash flow which is discounted using real time data with a spread to create a price.

At least some embodiments of the present invention can utilize an application service provider (ASP) (e.g., Exodus Communications, Santa Clara, Calif.), and have the functionality of the pricing module 110 reside with the ASP. The pricing module 110 can also convert data received from each or any of the data providers via data connections 104a, 104b, 104c into a common format prior to transmitting the data to the trading entities 102. The system 100 comprises one or more trading entities 102, although only one is provided in FIG. 1. Alternatively, each of the trading entities 102 can locally reformat the data received from each or any of the respective data providers. Insofar as there is no single central exchange for securities, the data provided by the data providers merely represent each of their respective best estimates of the current trading conditions. Users, therefore, may wish to compare prices for a given security or securities from two or more data providers. At least some embodiments of the present invention contemplate that the system 100 allows trading entities 102 and or their associated workstations 108a-n to select any of a plurality of data providers.

Trading entities 102, of which there may be any number, have one or more trading stations 108a-n at which an individual may, for example, search for market securities meeting predetermined criteria and/or execute a trade. As will be discussed in further detail herein, the trading entities 102 allow users to, for example, search the live securities market for securities satisfying one or more user specified parameters, and/ or buy and/or sell securities in a manner that automatically moves the seller into the live market or removes the buyer from the live market based upon one or more prespecified user parameters.

Trading entities 102 can also have an application server (not shown) to which one or more of the trading stations 108a-n are connected. Trading entities 102 having many trading stations 108a-n can be split/organized into more than one pool of user stations (e.g., 108a-g is a first pool, and 109h-n is a second pool), where each pool can optionally have its own dedicated application server (not shown). The trading stations 108a-n can also be configured in a fault-tolerant group (or groups) having a primary and a secondary application server, which each receive and process the same data. The primary server, assuming it is operational, can provide output to, for example, the pricing module 110 and/or the network 114, etc., as required. If the primary server is not operational, then the secondary server can receive and/or provide the required and/or desired input/output. Trading stations 102a-n can also optionally function in the alternative as thin-clients of an ASP. In such an architecture, the ASP provides the functionality of the application server (not shown).

The trading module 112 matches buy and sell trade orders from/between trading entities 102, as will be explained in further detail herein, and can also store information pertaining to, for example, trade histories, portfolio lines, auctions and auction bids, as well as the associated and dependent third-party data thereof for each trading entity 102. As in the case of a trading entity 102, the trading system 112 can be configured in a fault tolerant manner that minimizes and substantially equalizes any network 114 latencies between respective trading entities 102 and their associated trading stations 108a-n. TIB®/Rendevous software, available from TIBCO Software Inc., Palo Alto, Calif., can be used to minimize latencies. The trading module 112, the clearing module 106 and the trading entities 102 can be coupled via publish-subscribe messaging middleware, such as are available from Iona Technologies, Inc., Waltham, Mass., Talarian Corporation, Los Altos, Calif., and/or TIBCO Software Inc.

The clearing module 106 can be used to clear trades, and can store clearing data, data required for accounting purposes, operational data about trading entities 102 and/or system 100 users, as well as other data. During the course of purchasing and selling a fixed income security, a buying trading entity 102 and a selling trading entity 102 will not, during the course of the purchase and sale, exchange funds directly with each other. Instead, a clearing agent (e.g., a bank) will be used to broker the transaction. The clearing module 106 can be used to record transaction information pertaining to the respective buying and selling trading entities, and the clearing agent. For example, buying trading entity can provide funds to the clearing agent, who will in turn provide the funds to a selling trading entity. In turn, the clearing agent will accept the fixed income security from the selling trading entity, and deliver the fixed income security to the buying trading entity. The clearing module 106 monitors and records pertinent information pertaining to each of these transactions (e.g., dates, dollar amounts, etc.).

### Create Portfolio

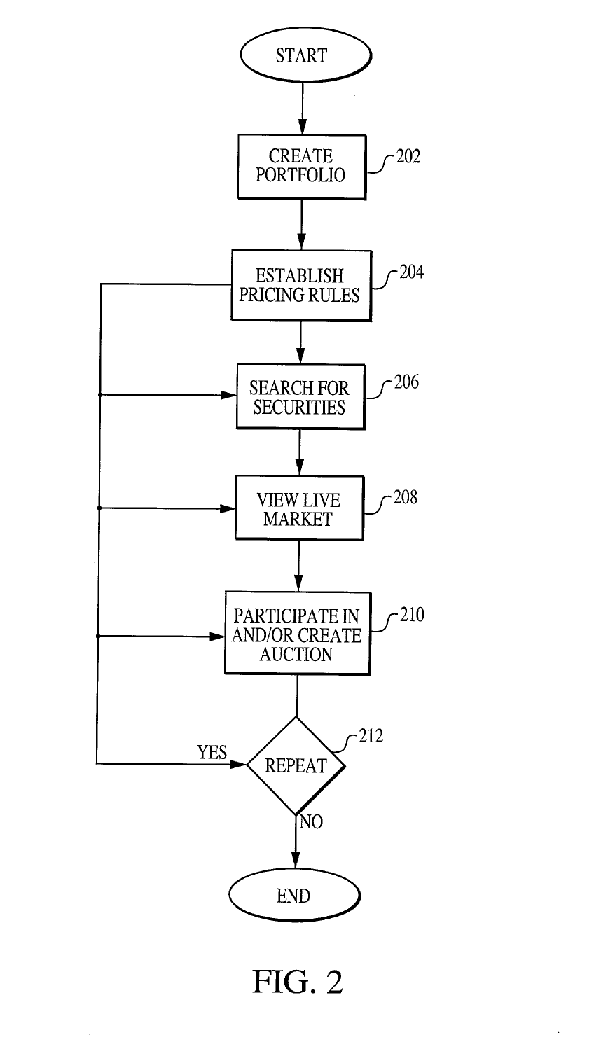

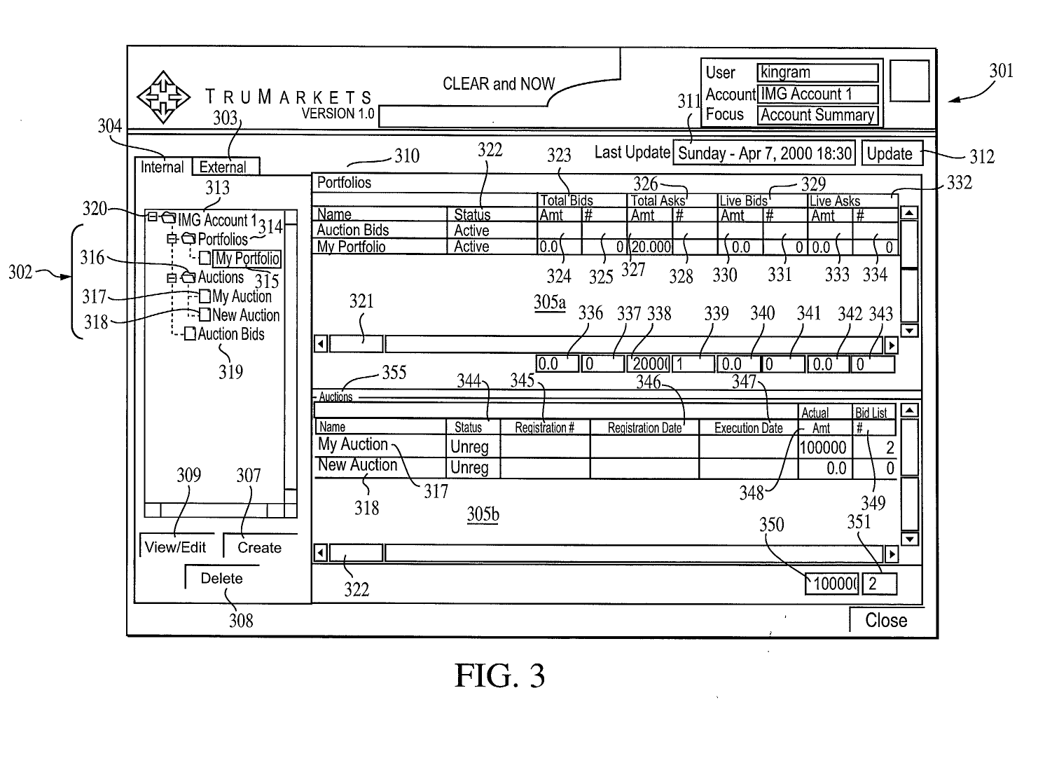

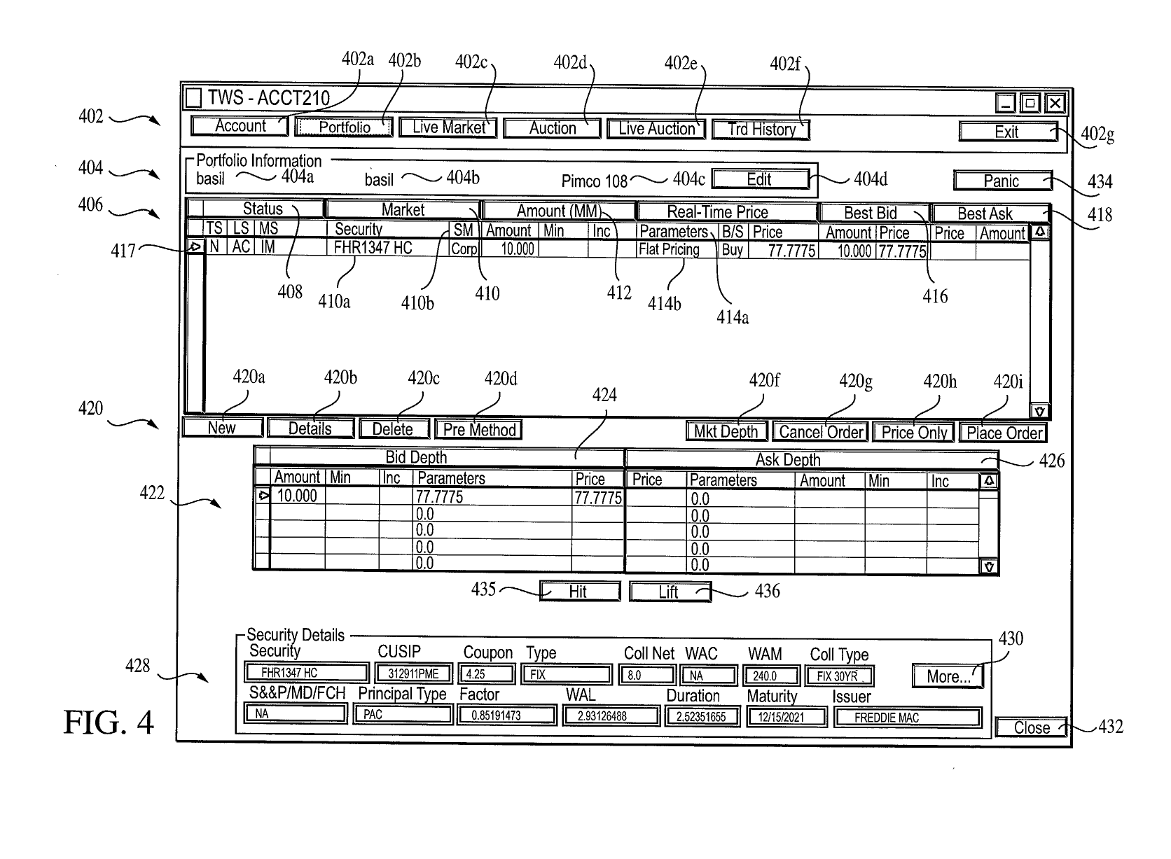

An exemplary high level flow diagram of a method according to the present invention is shown in FIG. 2. In block 202, an authorized user of the system 100 creates a portfolio line that describes a security or group of securities. For example, as shown in FIG. 3, a portfolio line 319 can identify one or more securities on which the user is currently actively bidding. Additionally, as shown in FIG. 4, and as discussed in further detail herein, a portfolio line 417 within a user's account can identify one or more securities of interest. A portfolio line 417 can have a security identifier 410a, the settlement method (e.g., corporate) 410b, amount 412 information, real-time price 414 information, etc.. As will be described in further detail with regard to FIG. 3, the system 100 will respond by enabling the user to enter detailed information pertaining to the portfolio line (e.g., 319, 417 ). The user can save the information within the system 100, using, e.g., one of the trading stations 108a-n of the trading entity 102 that the user is operating from.

FIG. 3 is an exemplary screen shot that shows a user account summary. Many of the terms discussed in the context of FIG. 3. will be further discussed with regard to subsequent figures. FIG. 3 enables a user to view and edit 309 portfolios 314, auctions 316 and auction bids 319 using, for example, a portfolio tree 302 that is familiar to most general computer users. User location 301 displays the user name (e.g., kingram), account (e.g., IMG Account1 ) and screen focus (e.g., Account Summary). By clicking on the expand or collapse buttons 320 the user can respectively display or hide various levels in the hierarchy. The IMG Account1 320 shows Portfolio folder 314, Auctions folder 316 and an Auction Bids file 319. The Portfolio folder 314 contains the My Portfolio file 315, whereas Auctions folder 316 contains the My Auction file 317 and the New Auction file 318. By clicking on the tab labeled external 303, the user can see his various accounts (i.e., any accounts in addition to IMG Account1 ( 313 )). To switch to a different account, the user simply highlights the desired account and clicks on the internal tab 304. While navigating the portfolio tree 302, the user can highlight a particular portfolio, auction, etc. which will cause the same selection to be highlighted in the respective Portfolio display area 305a or Auctions display area 305b.

Once generated, a portfolio line (e.g., 319, 417 ) is initially private (i.e., not submitted to the trading module 112 for other trading entities 102 to view). The user may subsequently broadcast the portfolio line. Portfolio lines can thus have broadcast status, meaning that they are submitted for viewing by other trading entities 102, or private status, meaning that they are not submitted for viewing by other trading entities 102. By keeping certain portfolio lines private, the user can utilize the system 100 to price all or a portion of a user's portfolio, without actually executing transactions. Portfolio lines can also have a third, dormant status. If a portfolio line is dormant, then it is not priced by the trading module 112 and is not viewable by other trading entities 102.

The pricing module 112 can be used to generate inquiry portfolio lines for individual securities and/or categories or types of securities. Inquiry portfolio lines are viewable by other users of the portfolio line market, but are not resolved by the trading module 112. Thus, no money is at risk with respect to inquiry portfolio lines. Users can examine securities to determine, for example, the interest level in a particular security or category of securities and/or whether a security matches specified trading criteria (e.g., type of security, coupon, price, maturity, etc.)

Display areas 305a, 305b act in much the same manner as a conventional spread sheet and allow the user to selectively display information by sizing the columns and/or by using the corresponding scroll bars 321 or 322. The items in display areas 305a, 305b correspond generally to those displayed by the portfolio tree 302. Each file entry (e.g., 315, 317, 318 ) in portfolio tree 302 has a corresponding line in the respective display area 305a, 305b. However, as shown, display areas 305a, 305b show more detail. For example, with respect to portfolios, the display 305a not only shows the file names, such as My Portfolio 315, but also shows the status (e.g., active (broadcast), or inactive (private or dormant)) 322 of the file, the total bids 323 in both amount 324 and number 325, the total asks 326 in both amount 327 and number 328, the Live Bids 329 in both amount 330 and number 331, and the Live Asks 332 in both amount 333 and number 334. Additionally, the display area 305a shows the overall totals for a particular account in the form of the number of bids in both amount 336 and number 337, the total asks in both amount 338 and number 339, the amount 340 and number 341 of live bids, as well as the amount 342 and number 343 of live asks.

With respect to the auctions display area 305b, file names such as My Auction 317 and New Auction 318 are displayed, as well as the status 344, the registration number 345, the registration date 346, the execution date 347, and the amount 348 and number 349 of any active bids on the particular auction. Additionally, the system displays the overall totals for the amount 350 and number 351 of active bids for all of the auctions listed in the account (e.g., IMG Account 1 ( 313 )).

The user can also switch to view/editing by highlighting a particular portfolio or auction bid and clicking on the View/Edit 309 button. A user can also create a new folder and/or file by clicking on the Create 307 button, and/or delete a particular portfolio or auction bid by clicking on the Delete button 308. Once satisfied by the changes made, if any, the user may click on the Update button 312 which sends the updated account information to the trading entity 102 and/or trading module 112. A display window 311 lets the user view the last time and date the account information had been updated. If the user clicks on the View/Edit button 309, the user is taken to FIG. 4.

FIG. 4 is an exemplary screen shot showing the details of a user portfolio. This form displays the portfolio name 404a, a description 404b of the portfolio, the default clearing account 404c, the option to edit 404d such information. Portfolio lines (e.g., 417 ) contained within the portfolio 404a are also displayed. Users can monitor live market activity 410 for all the securities that the lines within the portfolio are configured for. Users can broadcast 420i or privately price 420h any portfolio line contained within it, create new portfolio lines 420a, and/or edit 420b and/or delete 420c any existing portfolio lines.

The user can click on any of icons 402a-g, each of which present to the user a screen display corresponding to the icon clicked. Account button 402a would bring the user to a list of accounts within the system 100. The portfolio button 402b, which is currently activated as indicated by the dashed line thereon, presents a screen as shown in FIG. 4. The live market 402c, auction 402d, live auction 402e, and trade history 402f buttons bring the user to respective screens associated with these buttons, as will be discussed in further detail herein. The user can exit the account by pressing button 402g.

Menu section 406 provides information pertaining to status 408, market 410, amount 412, real time price 414, best bid 416, and best ask 418. Within status 408, further information is provide pertaining to trade status (TS) (i.e., is security bought or sold), line status (LS) (i.e., active or inactive), and market status (MS) (i.e., broadcast, private, or dormant). Market 410 information provides a security identifier 410a, and the settlement method (e.g., corporate) 410b. Amount 412 information provides the total quantity of original face value specified, the minimum specified, and the increment specified. Real-time price 414 information provides the active pricing method 414a, whether the user is buying or selling (B/S), and the real time price of the security 410a. The market's best bid 416 and best ask 418 each include information pertaining to the current best market amount and price.

Menu section 422 contains data regarding the existing market bids for a selected security. Specifically, when a user selects a portfolio line 417, the Bid Depth grid 424 displays the top bid orders that are currently in market for that security (e.g., 410a). The Bid Depth grid 424, as shown, contains information pertaining to the amount of the best bid, the minimum, amount of the best bid, the increment amount of the best bid, pricing parameters of the best bid, and the price of the best bid. Bids in the Bid Depth grid 424 can be sorted on, for example, the price, with the highest price first. Similarly, the Ask Depth Grid 426, as shown, contains data pertaining to the existing market of asks for a selected market. When the user selects a portfolio line 417, the Ask Depth grid 426 displays the best ask orders that are currently in market for the security that the selected portfolio line is configured for. The asks in the Ask Depth grid 426 can be sorted on, for example, the price, with the lowest price first.

Hit button 435 can be used when the user wants to hit one of the bids that he can currently see in the Bid Depth grid 424. Hitting can be used to configure an ask order that should trade with the selected bid. Because the hit order parameters are configured to match the selected bid, there is a good chance that the trade will occur. To hit a security, the user selects a bid in the Bid Depth grid 424 that has an amount that the user is interested in and price that he is willing to trade at, and clicks on the Hit button 435. When the Hit button 435 is clicked, a hit pop-up menu can be displayed to the user where he can provide trade-related information such as quantity of security, price, purchasing and selling parties, etc., and click on, for example, an ‘OK’ button to send a new order in market.

Similarly, Lift button 436 can be used when the user wants to lift one of the asks that he can currently see in the Ask Depth grid 426. Lifting is a quick way to configure a bid order that should trade with the selected ask. Because the hit order parameters are configured to match the selected ask, there is a good chance that the trade will occur. To lift a security, the user selects an ask in the Ask Depth grid 426 that has an amount that the user is interested in and price that he is willing to trade at, and clicks on the Lift button 436. When the lift button 436 is clicked, a Lift pop-up menu can be displayed to the user where he can provide trade related information such as quantity and price tolerance, and click, for example, an ‘OK’ button to send the order into the live market. This feature of the invention advantageously provides protection against adverse price movement in the live market.

The panic button 434 sets all the portfolio lines within the portfolio to dormant. The pricing for all the portfolio lines stops and all lines go out of market. Cancel button 420g closes the menu when pressed. The user may optionally be prompted to determine whether he wants to save any pending changes.

Line 420 allows a user to enter a new portfolio line 420a, view details 420b of a highlighted portfolio line, delete 420c a portfolio line, obtain additional real time pricing method parameters 420d, view information pertaining to market depth 420f, cancel an order 420g, view only the price 420h of a security (i.e., not place in the market), or place an order 420i.

Finally, area 428 provides detailed information pertaining to a particular security. Clicking on button 430 provides the user further detailed information pertaining to the selected security. Such information can include the product type of the security, the original balance of the security, the current balance of the security, the record date of the security, the beginning accrual date of the security, and the floor and gross coupon of the security. Other detailed information such as the weighted average life of the security, the collateral weighted average maturity, and the loan description of the security can also be provided. Additional details can also be provided and/or displayed. Finally, by clicking on button 432, the user exits the portfolio menu, and can be taken back to, for example, a main program menu.

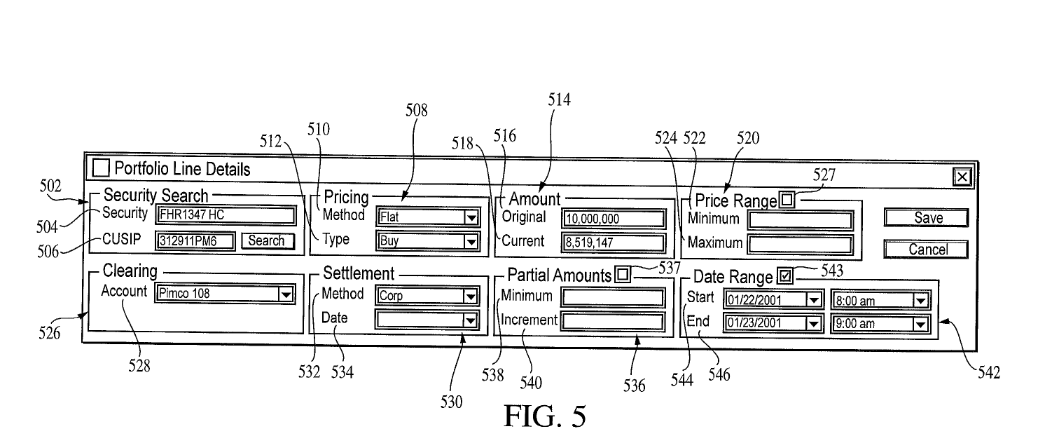

FIG. 5 shows the details of a portfolio line 417. FIG. 5 can appear when either the New button 420a or the Details button 420b is clicked, and is used to create a new portfolio line or to edit or view details or an existing portfolio line (e.g., 417 ). Security search area 502 identifies the security via security field 504 and CUSIP (i.e., Committee on Uniform Securities Identification Procedures) field 506. At least one of the fields 504, 506 is generally required to be filled in. Pricing area 508 includes fields for pricing method (e.g., flat, duration, spread, etc.) 510 and type (e.g., buy, sell) 512. Amount area 514 includes the original amount 516 specified for the security 504, 506, as well as the current amount 518, which can be automatically calculated and entered according to the formula: (amount * factor). Price range area 520 enables execution minimum 522 and maximum 524 amounts to be specified for the purchase or sale price of a security, and can be activated upon checking box 521. Clearing area 526 specifies the clearing account 528 to be used with the purchase or sale of the security 504, 506. Settlement area 530 provides the settlement method 532 (e.g., next, step, corporate, manual, etc.) and date 534. Partial amount area 536 enables minimum 538 and increments 540 amounts to be specified, which can optionally be activated when box 537 is checked. In date range area 542, a user can specify a start date 544 and an end date 546, which can be activated when box 543 is checked.

### Establish Pricing Rules

Referring again to FIG. 2, pricing rules are established, as indicated by block 204. There are at least three types of pricing methods that can be used to purchase and/or sell securities: flat pricing, duration pricing and spread pricing. Additional pricing methods, such as Option Adjusted Spread (OAS) pricing, can also be used with the present invention. The flat pricing method can be seen on FIG. 4 on security line 417 at 414a.

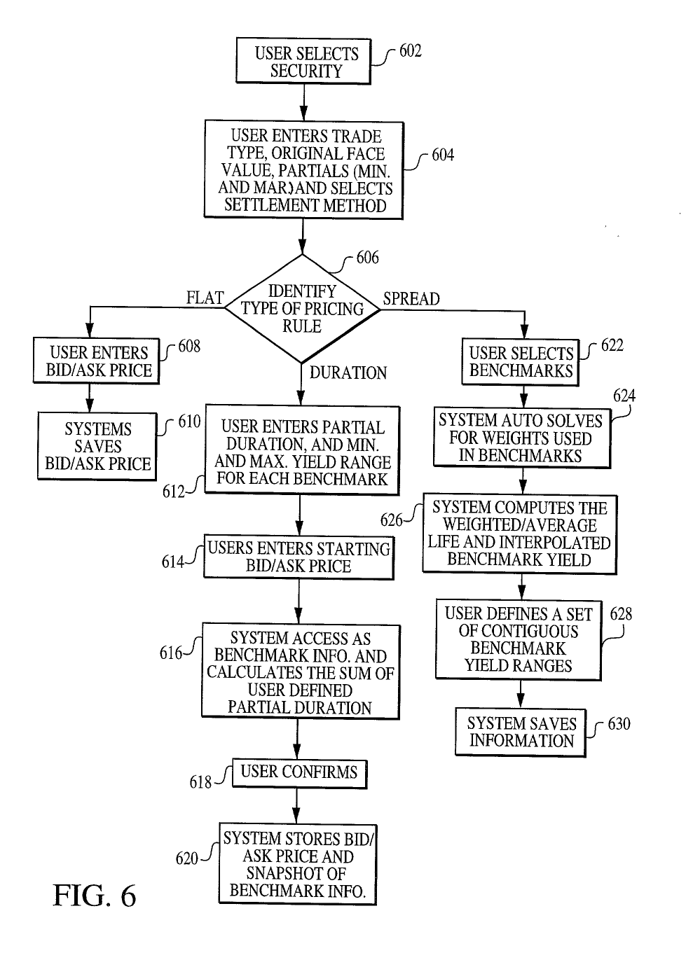

FIG. 6 is an exemplary flow diagram describing how users can select and submit portfolio lines in a preferred embodiment of the present invention. The user first selects 602 the security to be associated with the portfolio line, such as by CUSIP number 506 or other identifier 504. The user next enters data such as trade type (e.g., buy or sell), original security face value, and settlement method 604 for the portfolio line. As will be recognized by those skilled in the art of fixed income security trading, there are two settlement types: absolute and relative. Absolute settlement is typically used for trades in which the security itself decides the fixed settlement date regardless of the trade date. A relative settlement trade is determined as a number of business days from the trade date.

At block 606, the user identifies the type of pricing rule used for the portfolio line. The user may select, for example, flat pricing, duration pricing or spread pricing. As discussed above, other pricing models (e.g., OAS) can also be used.

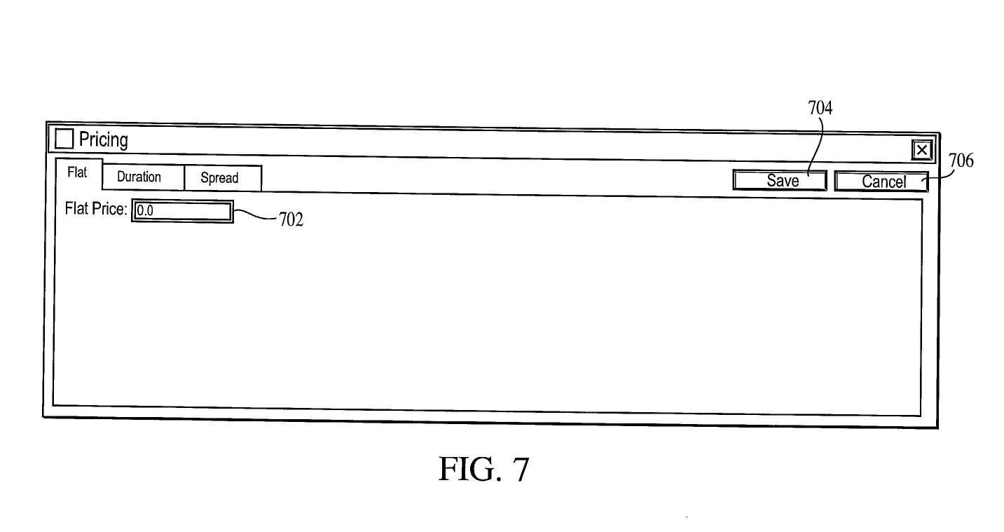

If flat pricing is selected, the user enters the bid or ask price 608 for the selected security or, as will be discussed, a bid or bid list item. The system 100 then saves the bid or ask price 610. FIG. 7 shows an exemplary screen shot that can be used with flat pricing. The user can enter the desired price in the price text box 702. By clicking on the Save button 704, the user may save the entered price. By clicking on the Cancel button 706, the user can exit the screen without having any changes saved by the system 100.

Returning to FIG. 6, if duration pricing is selected, the system 100 calculates the bid or ask price of the portfolio line according to the duration pricing model. As will be appreciated by those skilled in the art, duration pricing relates price changes in the security to price changes in one or more selected benchmarks. Users can specify a security start price and a corresponding start price for each selected benchmark. For each benchmark, the user can also specify the duration and a partial duration of the security. The real-time price of the security is calculated as the start price of the security plus weighted changes in the benchmark price(s), where the weight for each benchmark is the ratio of the partial duration of the security to the corresponding benchmark's duration.

The formula is as follows:

$$P = {P}_{0} + {\sum }_{b = 1}^{n} ( {δ}_{b} \times ( {P}_{b} - {P}_{b0} ) , where :$$

n=1,2, . . . , 5

P=Real-time price of the security

P₀=Starting price of the security

P_{b}=Real-time price of the benchmark b

P_{b0}=Starting price of the benchmark b

S_{b}=Ratio of the specified security's partial duration to the duration of the corresponding benchmark b.

The real time price of the security (P in the above formula) is only calculated if the real-time prices of the benchmarks fall within specified ranges. The trader specifies a benchmark price range by setting benchmark minimum and maximum prices for each of the benchmarks used for pricing a particular security. When the real-time price of any one of the selected benchmarks goes outside the specified range, the pricing of the portfolio line stops and the line goes out of the market (i.e., becomes inactive). The invention advantageously provides a feature that when the benchmark prices are back in range, the pricing resumes and the portfolio line goes back into the live market.

The user can select from one to five benchmarks, and specify 612 for each benchmark a partial duration and a minimum and maximum yield range. The invention can be adapted to accommodate any number of benchmarks greater than or equal to one. The user can also specify 614 a starting bid or ask price for the security. The system 100 can then access the benchmark information 616 provided by, for example, the third-party data feeds, and calculate the sum of the user defined partial durations. The user can then confirm 618 the duration pricing entries. If confirmed, the bid or ask price and/or a snapshot (e.g., security, price, etc.) of the benchmark information are saved 620.

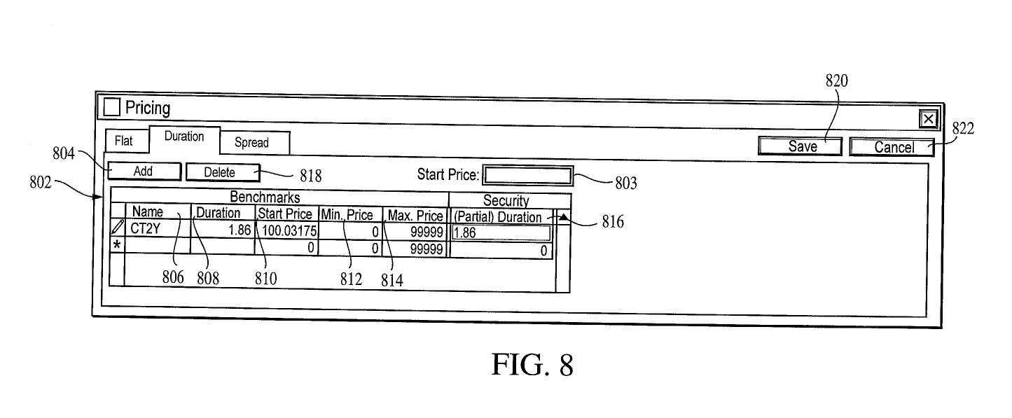

FIG. 8 is an exemplary screen shot that can be used with duration pricing. The benchmark window 802 can display the duration pricing parameters 803, 808, 810, 814, 816 of a selected portfolio line, if they were previously configured; otherwise those fields will be left blank. Security information such as the security name and/or CUSIP number, coupon, type (e.g., fixed or variable), maturity date; duration, weighted average life (WAL), factor, issuer, and/or the issuer's credit rating can also optionally be displayed in conjunction with FIG. 8. The start price 803 is the security start price, P, in the duration pricing formula. The selected benchmark(s) is/are displayed in area 802. By clicking on the Add button 804, additional securities can be searched for and added to the list of benchmarks 802. The list of benchmarks 802 also displays certain characteristics of the benchmark security and allows the user to modify certain other characteristics. A benchmarks can be removed by clicking on the delete button 818, once the desired benchmark has been highlighted in the benchmark list 802. Once finished setting up the duration pricing model for a given portfolio line, the user may click the save button 820 to save the user's changes, or click the cancel button 822 to cancel the user's changes.

Returning to FIG. 6, if spread pricing is selected, the system 100 calculates the bid or ask price of the portfolio line according to the spread pricing model. As will be further recognized by those skilled in the art, spread pricing is a discount rate-to-price calculation. This discount-rate is communicated to a spread-pricing calculator to determine the real-time price of the security. At least some embodiments of the present invention contemplate that the user can specify from one to five (or more) pricing scenarios, respectively corresponding to one to five specified yield ranges. Whenever the real-time benchmark yield falls within a specified range, the corresponding pricing scenario is used to calculate the spread price for the security. The present invention advantageously provides a feature that when the real-time benchmark yield moves outside of all the ranges configured, the spread pricing stops, the portfolio line stays out of the live market until the yield comes back within one of the specified ranges.

If only one benchmark is selected, the center yield preferably defaults to the end-of-day yield of the selected benchmark. If two benchmarks are selected, the center yield can default to a weighted average of the end-of-day yields of the two selected benchmarks. The center yield value can be edited by the user.

Calculation of the weighted average of the end-of-day yields of the two selected benchmarks can be accomplished in accordance with the following:

Weighted average=α*Y1+β*Y2

where:

Y1=end of day yield for benchmark 1

Y2=end of day yield for benchmark 2

α=Default yield weight for benchmark 1

β=Default yield weight for benchmark 2 [equal to (1−α)]

The preferred rules used to calculate the benchmark weights are as follows:

IM=The Interpolated Maturity (defaults to the weighted average life of the security)

BM1=The years to maturity of selected benchmark 1 (the shorter maturity of the two selected benchmarks)

BM2=The years to maturity of selected benchmark 2 (the longer maturity of the two selected benchmarks)

If BM1<IM<BM2 (i.e., if interpolated maturity falls between the weighted average lives of the two selected benchmarks)

Then IM is used in calculating α and β, where:

α=(IM−BM2)/(BM1−BM2)

If IM≦BM1

Then IM is not used in calculating α and β

IM is set to the value of BM1

α=1

If IM>BM2

Then IM is NOT used in calculating α and β

IM is set to the value of BM2

α=0

The user can edit the default benchmark yield weights (α and β) by over-writing them directly, or by over-writing the initial default calculation of IM.

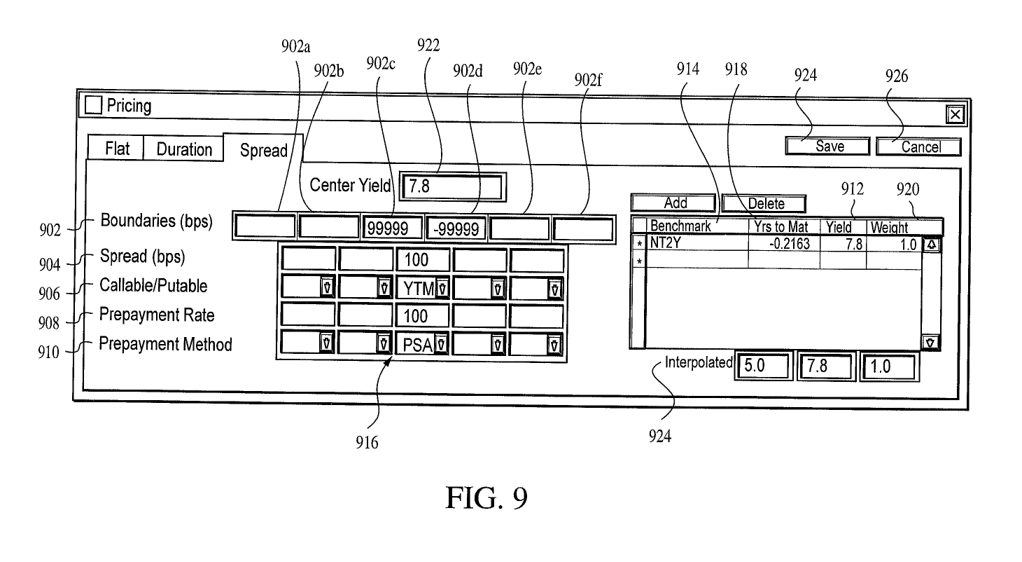

Returning to FIG. 6 in view of the above discussion, the user can select 622 one or more security benchmarks (e.g., IM2 and/or IM1). The system 100 then determines 624 the appropriate weights used for each benchmark. Alternatively, as discussed above, the user may enter weights for each benchmark. The system 100 then computes the weighted average life and interpolated benchmark yield 626, in accordance with the above formulas or, in the alternative, in accordance with other techniques widely known and accepted to those skilled in the art. The user can define a set of continuous benchmark yield ranges 628, after which time the system 100 saves such information. Security information such as, for example, the security name and/or CUSIP number, coupon, type (e.g., fixed or variable), maturity date, duration, weighted average life (WAL), factor, issuer, and/or the issuer's credit rating can also optionally be displayed in conjunction with FIG. 9. On line 902, the boundaries textboxes 902a-f, together with center yield 922, specify the range where real time benchmark yield 912 should fall in order to use pricing parameters (e.g. 916 ) specified right below two textboxes (e.g., 902c and 902d). The center yield 922 contains a user entered yield value that will be used together with values in boundary boxes 902a-f to determine yield ranges (e.g., 902c and 902d, in conjunction with center yield 922, determine one yield range). Depending on which yield range (e.g., 902a-b, 902b-c, 902c-d, 902d-e, 902e-f) the current benchmark yield falls in, a particular set of spread parameters specified below each yield range is used for pricing of, for example, a portfolio line.

The user can specify from one to five pricing scenarios corresponding to one to five specified yield ranges, where each of any two contiguous boxes on line 902 define a pricing scenario (e.g., boxes 902a and 902b; boxes 902e and 902f). Whenever the real-time benchmark yield 912 for a benchmark 914 falls within a specified range (e.g., the range defined by 902c and 902d relative to center yield 922 ), the corresponding pricing scenario is used to calculate the spread price for the security. When the real-time benchmark yield 912 moves outside of all the ranges configured in 902a-f, the spread pricing stops, and the user stays out of market until the yield comes back within one of the specified ranges (e.g., 902a-b, 902b-c, 902 c-d, 902d-e, 902e-f).

The numbers within spread textboxes shown on line 904 (one for each pricing scenario) are preferably entered in basis points, and added to the real-time benchmark yield 912, which determines the rate at which the cash flow is discounted to determine the price. The system selects one of the specified spreads based on the current value of the benchmark yield 912, center yield 922, and boundaries specified by trader.

The callable/putable line 906 can be used to enable the user to indicate whether the security is callable or puttable. Prepayment rate line 908 enables a user to enter a prepayment rate to estimate the cashflows for the security. As will be understood by those skilled in the art, corporate bonds generally do not have prepayment speeds associated therewith. The system 100 can select one of the prepayment rates based on the current value of the benchmark yield 912, center yield 922, and boundaries 902a-f specified by trader.

Prepayment method boxes 910 allow a user to select the prepayment method (e.g., PSA, which is the Bond Market Trade Association's Mortgage Asset-Backed Securities Division's prepayment model) used to estimate the cashflows for the security. The system 100 selects one of the specified prepayment methods based on the current value of the benchmark yield 912, center yield 922 and boundaries 902a-f specified by trader.

In addition to end-of-day yield 912, the summary information about the selected benchmark 914 can also include years to maturity 918 and weight 920. If the benchmark 914 added is a first benchmark, the weight defaults to 1. If two benchmarks are selected, the center yield 922 defaults to a weighted average of the end-of-day yields of the two selected benchmarks, but can be edited by the user. The user can accept or over-write the center yield 922 or the benchmark weights or interpolated maturity 924. The user can also save 924 or cancel 926 the spread pricing configuration. In conjunction with both the duration and spread pricing methods, it should be understood that the user can select one or more benchmarks from a list of benchmarks that can be presented to the user.

### Search for Securities

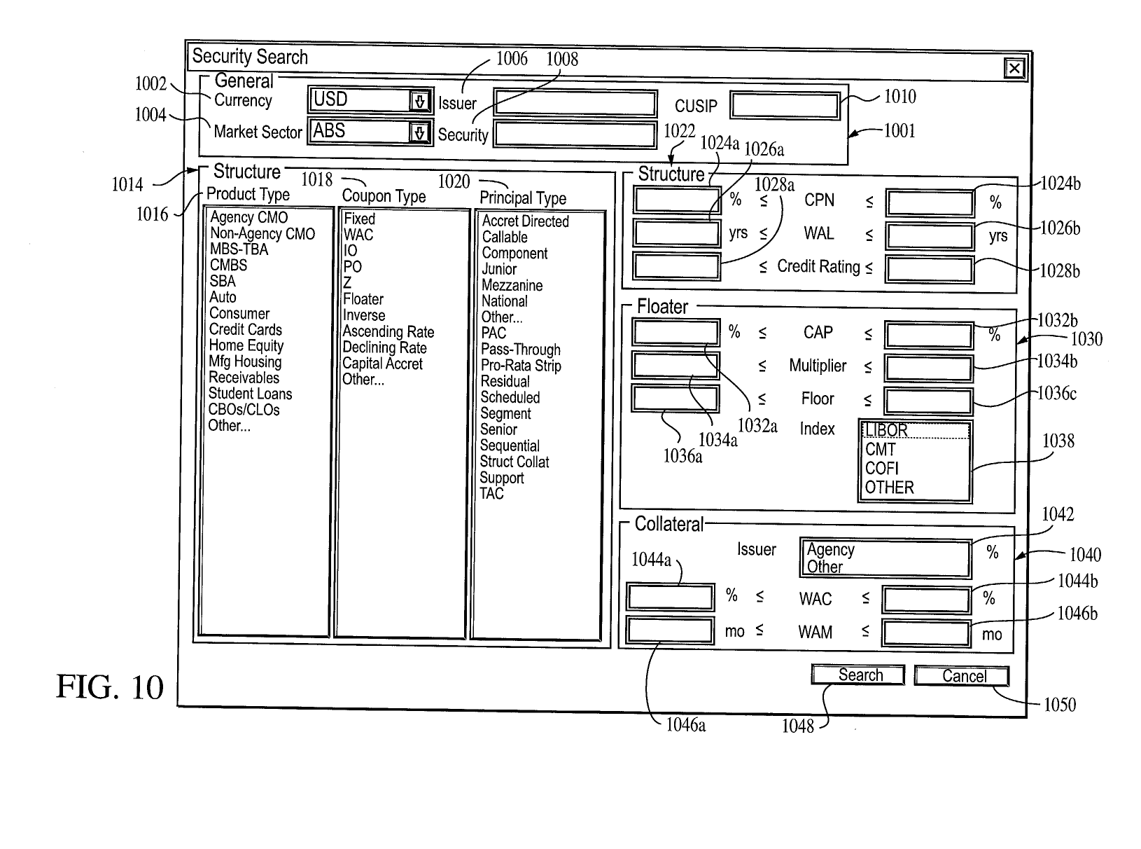

Returning to FIG. 2, the system 100 also advantageously enables a user to search for securities 206 that, for example, a user may have an interest in purchasing. FIG. 10 shows an exemplary search screen that enables a user to search for securities matching one or more user selected criteria. In section 1001, the user can search for a security (or securities) by currency (e.g., United States dollars) 1002, market sector 1004, issuer 1006, security name 1008 and/or CUSIP 1010. Within structure area 1014, the search may also be limited in addition to or in lieu of criteria specified in general section 1001 by using search criteria such as product type 1016, coupon type 1018 and/or principal type 1020.

In security area 1022, a coupon rate minimum 1024a and/or coupon rate maximum 1024b, a minimum weighted average life (WAL) 1026a and/or a maximum WAL 1026b, and/or a minimum credit rating 1028a and/or a maximum credit rating 1028b can be specified. In the floater area 1030, minimum 1032a and/or maximum 1032b ranges may also be entered for the CAP (i.e., interest rate cap to which a floating security can adjust up to), multiplier 1034a, 1034b, and/or floor 1036a, 1036b. The user can also select and search for securities that index their floater in a particular way by selecting from index list 1038. Finally, in the collateral area 1040, the user may enter and search based on the issuer 1042, maximum 1044a and/or minimum 1004 weighted average coupon (WAC), and/or maximum 1046a and/or minimum, weighted average maturity (WAM) 1046b. Then by clicking on the search tab 1048, the user can view the list of securities that meet selected criteria. A search can also be canceled 1050.

### View Live Market

Returning to FIG. 2, a user can also view the live market 208 (obtaining information from, e.g., data lines 104a-c). To view the market for a particular security or securities, the user uses the live market filter, which can closely resemble in both function and display the security search interface shown in FIG. 10. For example, FIG. 10 can be modified to include an indicator that shows that the user's focus is the live market. The results for securities of interest to a user that are in the live market can be displayed to the user upon completion of the search.

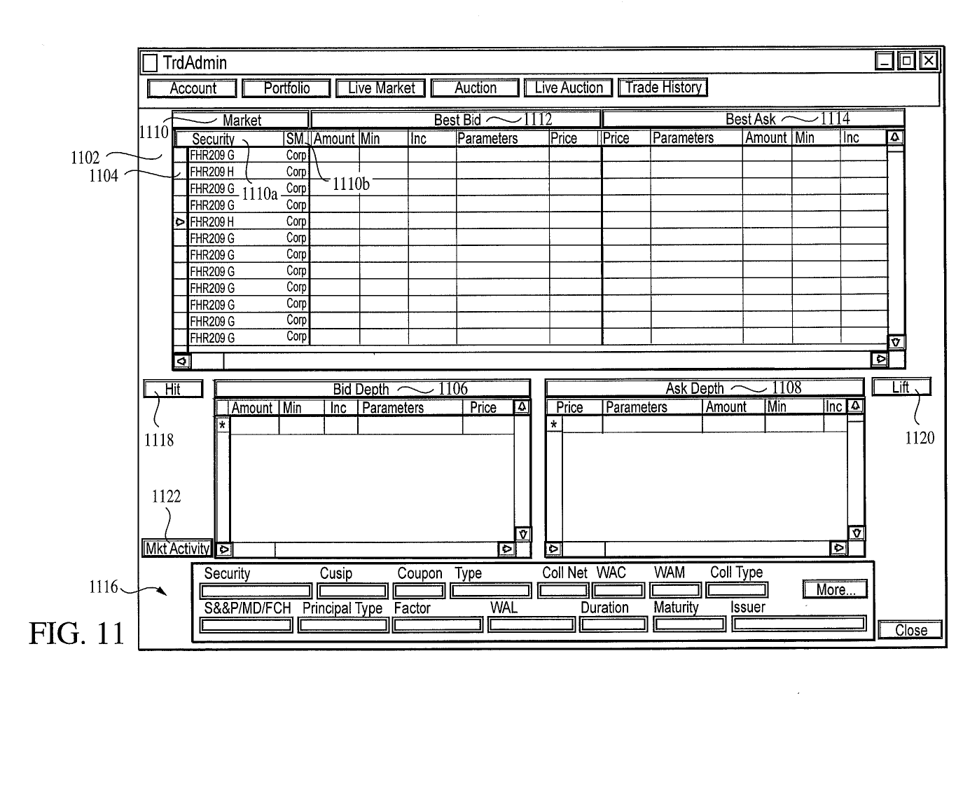

FIG. 11 shows an exemplary live market screen shot, that enables a user to monitor current market activity in the system and create hit or lift orders against currently available securities. FIG. 11 can show, e.g., only the securities (e.g., 1102, 1104, etc.) that match filter criteria specified via a security search as can be done with FIG. 10. For each security available on FIG. 11, the user can also view the top bids 1106 and asks 1108 configured against it.

Market area 1110 contains a grid displaying a list of securities 1110a that match filter criteria and that the trading module 112 is currently broadcasting orders for. The grid displays the best bid 1112 and best ask 1114 information for this security. Additional ask and bid orders for a security currently in market the other orders can be displayed/viewed in the respective depth grids 1106, 1108. The Best Bid 1112 and Best Ask 1114 is analogous to that discussed with regard to FIGs. 4 and 5. The security detail area 1116 also contains information that is the same as or similar to that shown on FIG. 4. The hit 1118 and lift 1120 buttons have a functionality that is the same as or very similar to those discussed in regard to FIG. 4.

When the Market Activity button 1122 is pressed, a screen can appear (not shown) that preferably contains the same information as the Bid Depth 1106 and Ask Depth 1108. The Market Activity screen (not shown) can be used when a user wants to monitor Live Market activity for a specific line, while working on any other screen.

### Auction Creation and Participation

Referring again to FIG. 2, the system also allows users to participate in and/or create auctions 210. Users can openly market and trade securities. The present invention advantageously allows users to promote the purchase and/or sale of one or more securities with anonymity. Users can also generate a display of all auctioned securities that satisfy one or more user specified criteria. Users can also view the breadth and depth of bids in auctions.

An auction can consist of certain parameters that govern the auction: date/time of execution, settlement method, public bidding, etc., and a list of auction (ask) orders, referred to as the auction's “bid list.” An auction can be sent to the live market (i.e., broadcast) once the auctioneer has named the auction, specified its parameters, and created a bid list of ask orders. For each bid list item for which the auctioneer elects to have a reserve price, a pricing method is specified; and for each bid list item, amounts (including minimum and increment) and settlement method are specified. Upon broadcasting an auction, each item in the bid list is viewable by the market at large, and thus may generate multiple bid orders configured and submitted by various traders (other than the auctioneer).

A trader who wants to bid on a broadcast auction can create a bid by specifying amounts (including minimum and increment) and a pricing method for the bid. Upon broadcast, the auction remains open for additional bids up until execution time, at which time the pricing module 112 performs matching on the auction. After the match processing, all orders associated with the auction can be deleted from the market, set to dormant status, and given a market status of “resolved”.

The system 100 can support at least two types of auctions: blind and public. Bids configured against a public auction are visible to other traders, while bids against a blind auction are not displayed to other traders. For this reason, start time of a blind auction is the same as the execution time. The system can support both buy-side and sell-side auctions.

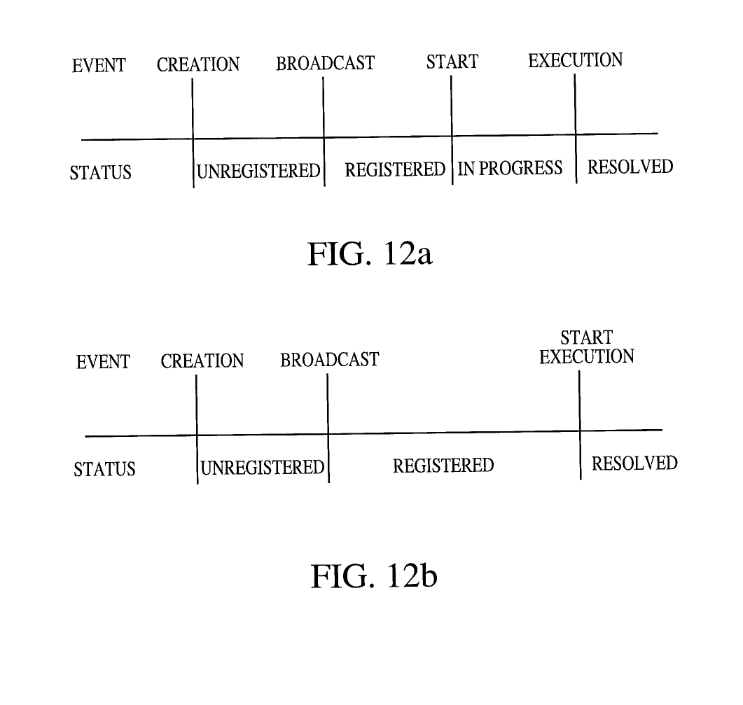

FIG. 12a provides a mapping of a public auction life cycle to its statuses, and FIG. 12b provides a mapping of a blind auction life cycle to its statuses. With regard to FIGS. 12a and 12b, a user within a trading entity 102 can suspend an auction any time between Broadcast and Execution.

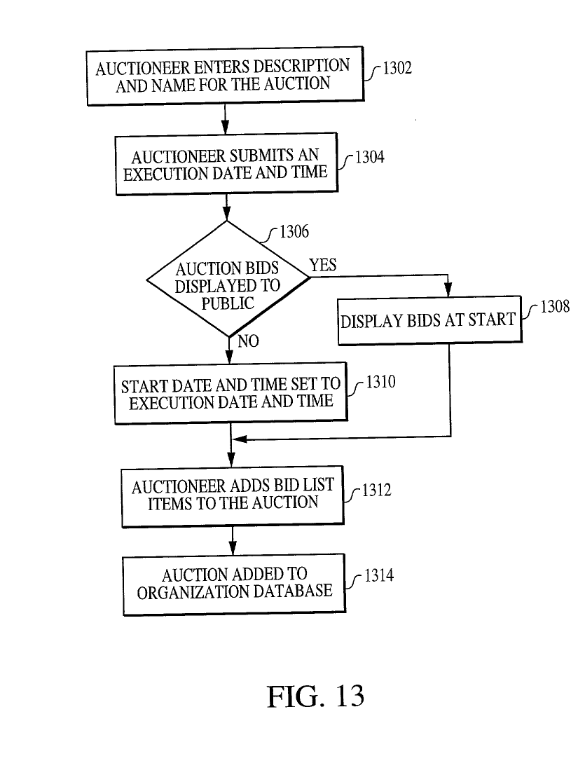

Creation of an auction is an event local to a trading entity 102. The general steps for creating an auction, either blind or public, are similar except for certain rules regarding the visibility of submitted auction bids. FIG. 13 shows an exemplary method of creating auctions. A user, by establishing an auction, becomes an auctioneer. The auctioneer can define a particular auction by entering, for example, a description and auction name for the auction 1302. This name and description is used internally by the auctioneer. Other information used to define the auction may optionally include execution date/time, auction type, and a clearing account. In at least some embodiments contemplated by the present invention, the minimum information requirement needed to save a new auction comprises an auction name and clearing account. If the auction type is public, then the start date/time for public display of bids is defined. The user also specifies a bid list, which is a set of securities to be sold in an auction.

The auctioneer then inputs a requested execution date and time for the auction 1304. The system 100 can limit the options for execution date(s) and time(s) for uniformity amongst users. If the auctioneer chooses 1306 to display auction bids to the public, the system 100 displays 1308 bids at the auction start date and time, after which the auctioneer adds bid list items to the auction 1312. If the auctioneer chooses not to display auction bids to the public 1306, the auction start date and time is automatically set to the execution date and time 1310. The auctioneer may optionally add portfolio line items 1312 to the auction prior to or after saving the auction 1314 to, for example, a database.

Once the auctioneer selects the auction that contains the portfolio line or lines to be offered, the auctioneer can specify the security, a reserve price (if desired), a reserve pricing model (e.g., fixed, duration, spread, etc.), a quantity, and any quantity rules (such as partials, minimums or increments). The system 100 can optionally limit auctions to a minimum total face value (e.g., one million dollars, ten million dollars, etc.). If the face value of a single list item is less than or equal to the minimum, then the system 100 can flag the list item as an odd lot item.

If the auctioneer is using a reserve price, the auctioneer also selects a pricing model to be used for the reserve price using, for example, the method described above with respect to creating portfolio lines. Additionally, the auctioneer can specify whether a partial order with respect to quantity will be acceptable. If partial orders are acceptable, the auctioneer can further specify the minimum order and the increment. Finally, the auctioneer can specify a settlement method type (e.g., skip, corporate, same day, manual, etc.).

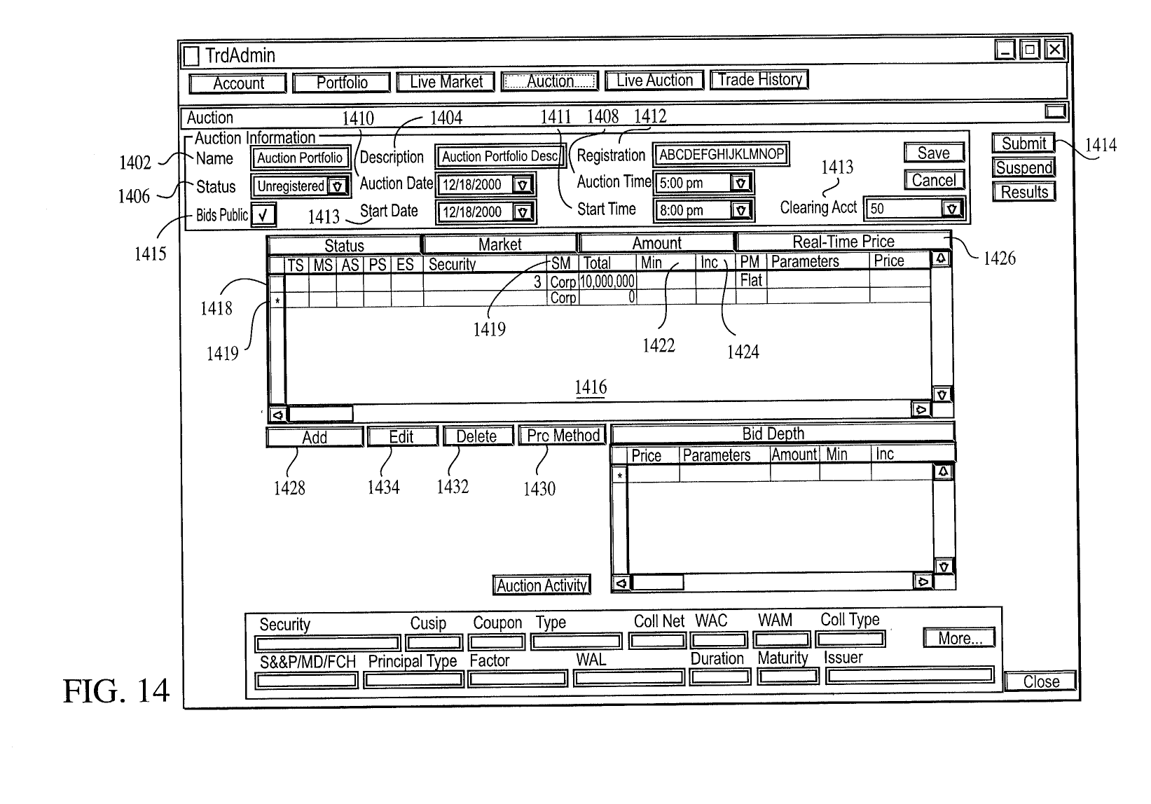

FIG. 14 shows an exemplary screen shot in which a user can create and maintain an auction with auction bid list items. The user can privately price bid list items prior to auction submission, monitor auction activity once the auction has commenced, and transition to the auction results screen to view the results of an auction.

The auctioneer enters or views the name of the auction 1402 and a brief description 1404 of the auction 1402, and can also view the status 1406 of the auction (e.g., registered or unregistered). The auctioneer can also select the current auction time 1408 and the auction date 1410, as well as the start time 1411 and date 1413 at which the auction began. A user can click box 1415 to make the auction public; otherwise, the auction will remain private. To register (i.e., broadcast) an auction 1402, the auctioneer clicks the submit button 1414. If the auction 1402 is broadcast, it receives a registration number 1412. Until such time as the auction is broadcast, the user can privately price configured bid list items that have a reserve price. To determine whether a bid list item has a reserve price, button 1430 on FIG. 14 can be pressed. These privately priced bid list items are preferably not visible to traders on the live screens, and thus will not be traded. To make an auction visible to the public, it must be broadcast. The user can make any modifications to an auction at any time up until the auction is broadcast. Once an auction has been broadcast, a user preferably can change only the auction name 1402. It is preferred that the only thing that can be done to an auction after it has been broadcast is to cancel it. The clearing account 1413 used in connection with the auction is also provided.

The securities that comprise the auction 1402 (i.e., the bid list) are listed in the display 1416. In this particular example only two securities 1418, 1419 are shown. A user does not have to create any bid list of items at the time of auction creation. Bid list items (e.g., 1418 ) can be created, edited or deleted any time after an auction is created and before it is broadcast by, for example, clicking the submit button 1414. The display 1416 also conveys the settlement method (e.g., corporate) 1419, amount 1420, the minimum 1422 and incremental partial 1424 (if selected), and the real-time pricing 1426. Additional securities may be added to an auction by clicking the New button 1428, and existing securities may be edited by, for example, double clicking on a highlighted security line (e.g., 1418 ). The pricing method can be altered by clicking the Prc Method button 1430. Finally the auctioneer may delete a security from the auction be clicking the Delete button 1432, or display additional details by clicking Details button 1434.

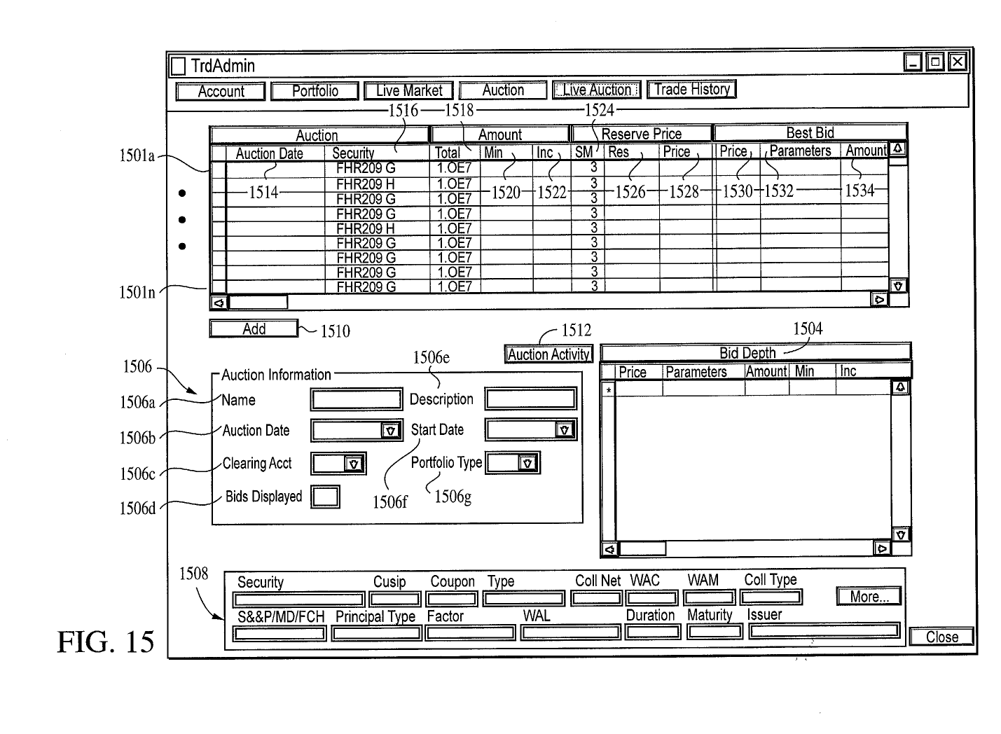

When the auction is broadcast, bid-list items begin to be priced and become visible on a Live Auction viewer, as shown in FIG. 15. Users can monitor auction activity in the system 100 and configure bids against any broadcast bid list item. User can also view bid list items from registered auctions that match filter criteria specified via a filter screen similar to that shown in FIG. 10. For bid list items that are a part of public auctions in progress, users can also see bids configured against the bid list items being viewed.

FIG. 15 preferably defaults displaying all auction bid list items 1501a-n that are currently broadcast by the trading module 112 and that match filter criteria as specified in a search filter similar to that of FIG. 10. Bid Depth area 1504 contains a grid displaying bids configured against the bid list item selected in the Bid List Items area 1501a-n. Auction Information area 1506 contains fields displaying auction details of the bid list item selected in the Auction Bid grid. Security Detail area 1508 provides a summary of the security information for a selected bid list item. Add button 1510 can be used to create a bid against a bid list item 1501a-n. Auction Activity button can be used to show the bidding history for the price and/or quantities of a given security or securities.

Auction data 1514 provides the date/time of an auction to which the auction item belongs. Security 1516 is a short name of the security for which the auction item is configured. Total 1518 is the total amount of the respective auction item 1501a-n. Min 1520 is the lowest partial minimum amount of the auction item 1501a-n that will be accepted. Inc 1522 is the partial increment amount of the auction item. SM 1524 is the settlement method of the auction item. Res 1526 is an indicator of whether reserve price is used to price auction item. Price 1528 is the reserve price of the auction item 1501a-n. Best bid price 1530 is the best bid price; parameters 1532 are the pricing parameters for the best bid, and amount 1534 is the best bid amount.

Within bid depth area 1504, all bids configured against an auction item 1501a-n can be displayed. The information displayed is preferably in real-time or substantially real-time and is only displayed if the selected auction item is a part of an auction that is currently in progress. Bids in the grid are preferably sorted on the price 1530, with the best price at the top. The Bid Depth elements (i.e., price, parameters, Amt, Min and Inc) are as described with regard to FIG. 4.

The Auction Information area 1506 includes the Name, which can be a registration number assigned by the trading module 112. The Auction Date 1506b is an execution date/time of an auction that the bid list item (e.g., 1501a-n) is a part of. The Clearing Account 1506c is the clearing account associated with the bid list item. Bids Displayed 1506d provides an indication of whether the selected bid list item is a publicly accessible bid. Description 1506e can be used to provide a description of an auction that the bid list item is a part of. Start Date 1506f is the start date/time of an auction that the bid list item is a part of. Portfolio Type 1506g is a way to save the portfolio (e.g., FIG. 3,314 ).

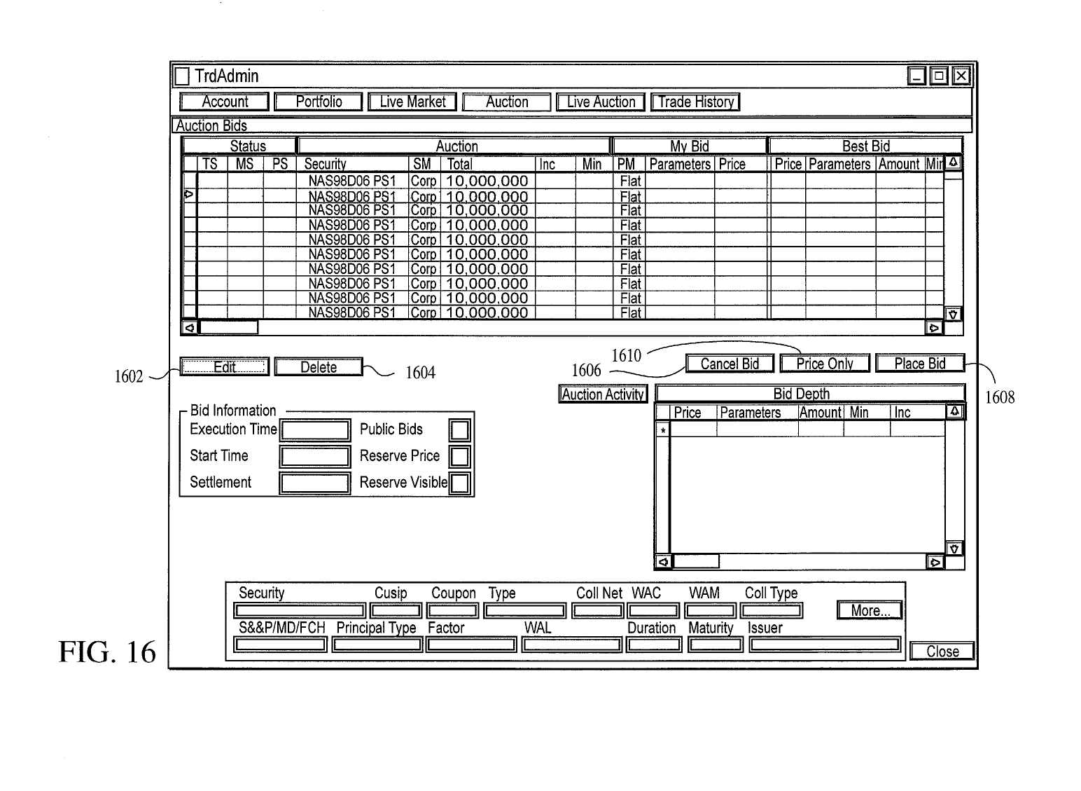

FIG. 16 is an exemplary Auction Bid Portfolio screen shot, and shares may features of FIGS. 14 and 15. FIG. 16 enables a user to maintain auction bids that are configured in the current account against any auctions, and also allows a user to edit 1602, delete 1604, cancel 1606, place 1608 and privately price 1610 auction bids. When the Place button 1608 is clicked, the trading module 112 begins to calculate price for the bid and broadcast the bid information to the auction. If the auction in which the bid is entered supports public bidding, the bid will be visible at other trading entities 102. The Price Only button 1610 can be used when a user wants to privately price a bid. When the Price Only button 1610 is clicked, the trading module 112 begins to price the bid and broadcast the price to the trading entity 102 to which the bid belongs. The bid is thus not yet part of the auction yet.

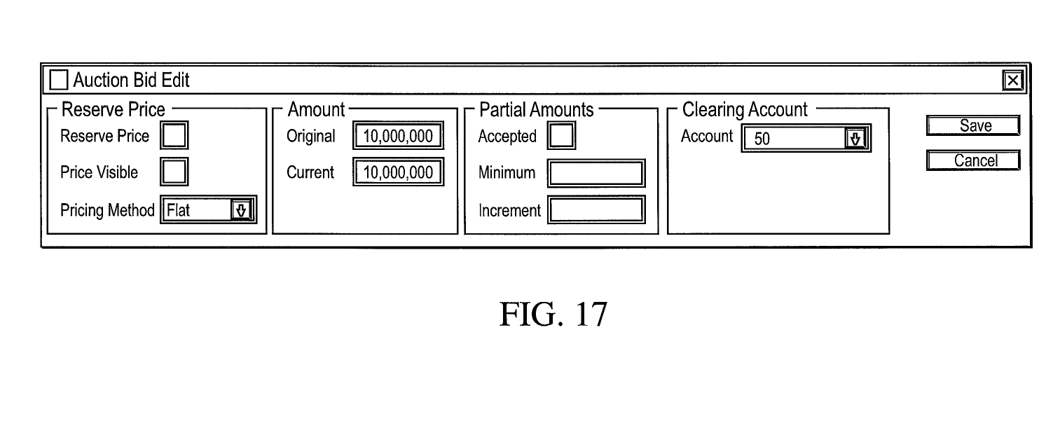

FIG. 17 is an exemplary screen shot that allows a user to create, edit or view an auction bid configured to participate in an auction. FIG. 17 can be accessed either from Live Auction screen (FIG. 15) when, for example, the user wants to configure a new auction bid in an auction, or from Auction Bid portfolio (FIG. 16) when, for example, a user wants to edit or view the details of an already existing auction bid.

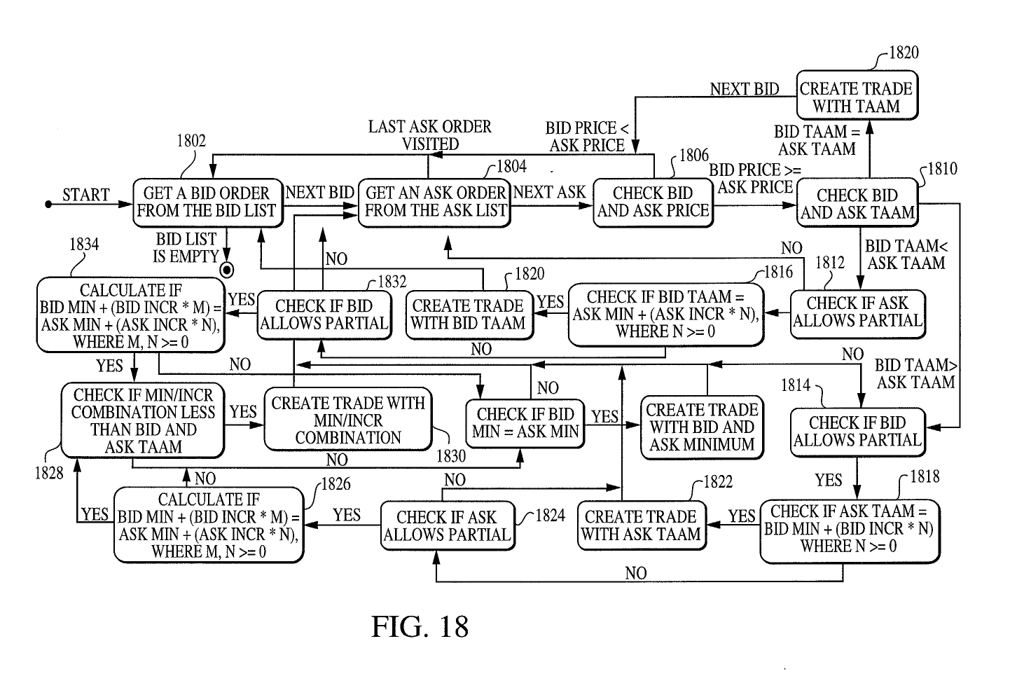

FIG. 18 is an exemplary flow chart showing how bid orders are matched against ask orders for the live market. The method in accordance with FIG. 18 operates by taking a bid order from the bid list 1802 and matching it against the ask list 1804. Price matching occurs by taking a bid price and comparing against an ask price. If a bid price is higher than the asking price a trade can be considered. A trade is executed using the average of the bid and ask price as the execution price. Bids continue to be removed from the bid list until the entire list is consumed. Any bid or ask orders not matched at the end of the matching cycle are placed back into a reservoir of market orders and processed again.

When a bid order is matched against an ask order with a higher price 1806, the matching algorithm can stop processing for this bid order. It is preferred that the ask list is sorted from lowest to highest price and if a higher ask price is encountered, all other asking prices that fall after will also be higher. Consequently, there is no reason for further checking. Similarly, if the current bid price is lower than the first ask price in the ask list then all other bids that follows will also be lower. Matching can be stopped for this market.

The requirement is to make amount comparison, and check for partial, minimum, and increment. Partial, minimum and increment are checked only if the Total Amount Available for Matching (TAAM) for bid and ask are not equal 1810. The TAAM can be defined as the original amount of a security less any partial execution(s). For example, if a security is priced at $10 million, and a $2 million partial bid has been executed, then the remaining matching amount is $8 million. If a bid/ask order has not partially traded in previous market cycles, then the TAAM is the original order amount configured by the bidder/offeror; if a bid/ask order has partially traded in one or more previous market cycles, then the TAAM is the originally configured order amount decremented by the amount of each partial trade that has occurred.

The next step is inspecting the partial flag when the bid and ask TAAM are different 812, 1814. At least one (of a bid/ask pair) order must allow for partial, and that order must have the higher TAAM. If a valid partial (partial flag set with a higher TAAM for one of the orders) is set, then continue checking for the minimum and increment 1816, 1818. Users can optionally request that an order is to be traded with the entire amount only, an “all-or-none” trade. This is done by specifying a non-partial order.

A bid/ask TAAM must be at least equal to or greater than the minimum of the other. Otherwise, it is not a trade 1820, 1822. If the bid/ask order was involved in a trade earlier that resulted in a TAAM less than its own minimum, then the order is effectively filled and should not be traded again. Effectively filled orders are set to “dormant” and are not traded or priced. If a bid/ask TAAM is equal to the bid/ask minimum, then a trade is can be executed with the minimum amount, and increment checking ( 1822, 1824, 1826, 1828, 1830, 1832, 1834 ) is not required. If the bid/ask TAAM is greater than the bid/ask minimum amount then the increment needs to be checked. An exception to the rule is when bid and ask minimums have the same value. A trade at the common minimum value 1820 is possible only if the matching algorithm does not find a higher minimum/increment value.

A bid/ask TAAM that satisfies the minimum also needs to meet the required increments. For example, when a bid/ask TAAM is 10, a minimum of 4, and an increment of 2, valid partial (VP) trades are 4, 6, or 8. In general, a VP is a quantity that is: (1) equal to the bid/ask minimum amount+(N * bid/ask increment), where N is any positive integer, and (2) less than the bid and ask TAAM. An increment of zero (settable by traders) would provide trades only at minimum amount or TAAM.

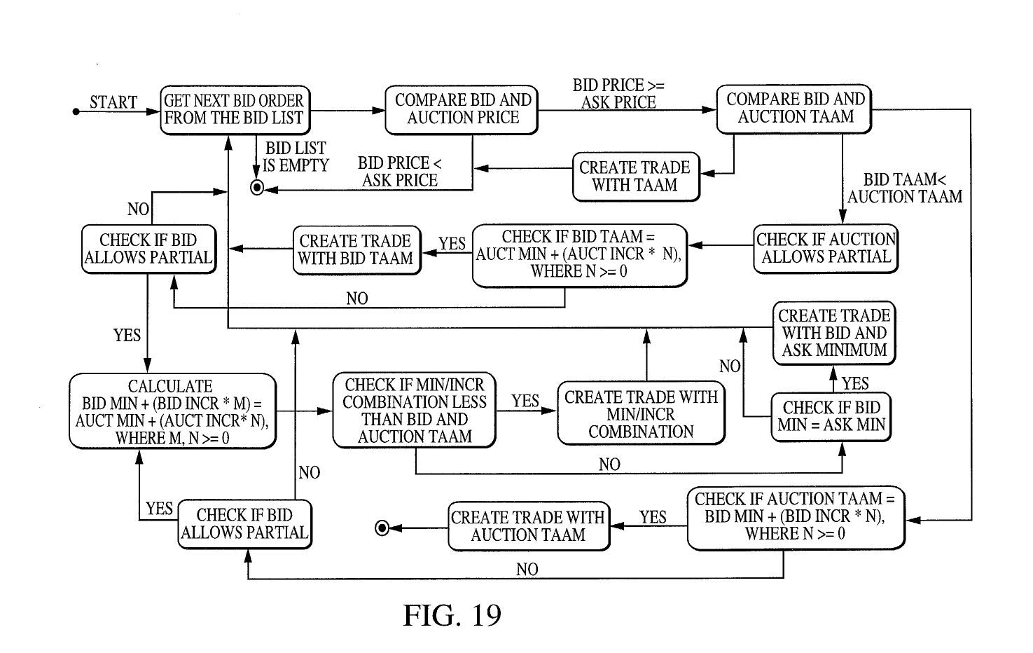

FIG. 19 is a flow chart of the match process for an auction. The method is essentially the same as the matching algorithm for live markets as shown in FIG. 18. In FIG. 19, however, matching is done only once at execution time and the execution price is the bid price, subject to the auction reserve price.

### Third Party Integration/Clearing Processing

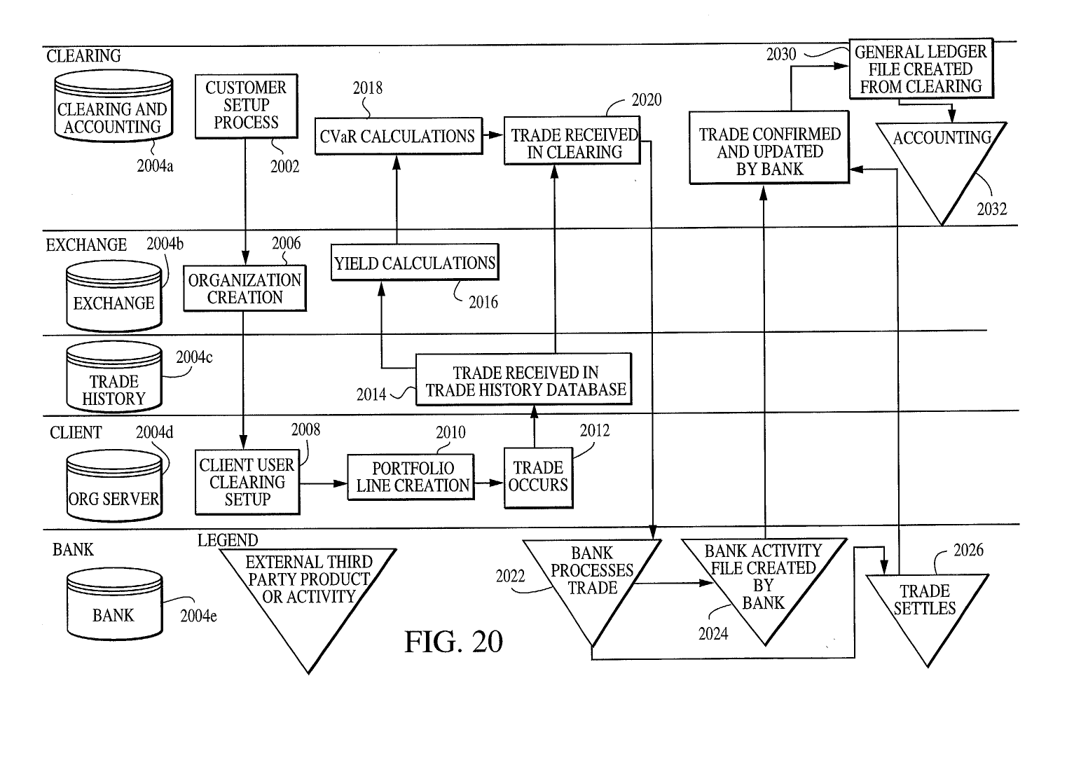

FIG. 20 is an exemplary flow diagram of an overall business workflow of the present invention. The process begins at block 2002 with the customer setup process. Here, the customer (i.e., trading entity 102 ) can be registered with, for example, a database 2004a associated with the clearing module 106 by providing information such as organization/entity name and/or clearing information (e.g., clearing bank, account number, etc.). At block 2006, the customer can also be registered with the trading module 112. Registration at the trading module 112, via database 2004b, enables trading entities 102 to execute trades, whereas registration with the clearing module 102, via database 2004a, allows executed trades to clear.

At block 2008 information (e.g., user names, and system 100 rights and privileges for each user, etc.) for individual traders and other users who can access the system 100 can also be entered. At block 2010, as previously discussed, one or more portfolio lines 2010 (e.g., FIG. 3, 319 ) can also be created and/or associated with each individual user established at block 2008.

When a user executes a trade 2012, the trade-related information 2014 (e.g., trading parties, buy/sell price, trade date, etc.) can be entered into a database 2004c. Yield calculations 2016 and Credit Value at Risk (CVaR) calculations 2018 can also be performed. At block 2020, the clearing module 106 receives the CVaR calculations 2018 (which measure credit exposure to a particular trade) and the information 2014 from the trade history database 2004c (e.g., price, quantity of a security, CVaR, the counter party, etc.). A clearing agent (e.g., a bank) can process the trade 2022. The clearing agent can create an activity file 2024 that contains trade related information (e.g., parties involved in the trade, security bought/sold, price, etc.) and trade settlement data 2026. At block 2028, the activity file 2024 information and settlement information 2026 can be passed to the clearing module 106. Within the clearing module 106, a general ledger file can be created and/or used 2030 using for example, an accounting software product 2032 such as developed by Epicor Software Corporation, Irvine, Calif.

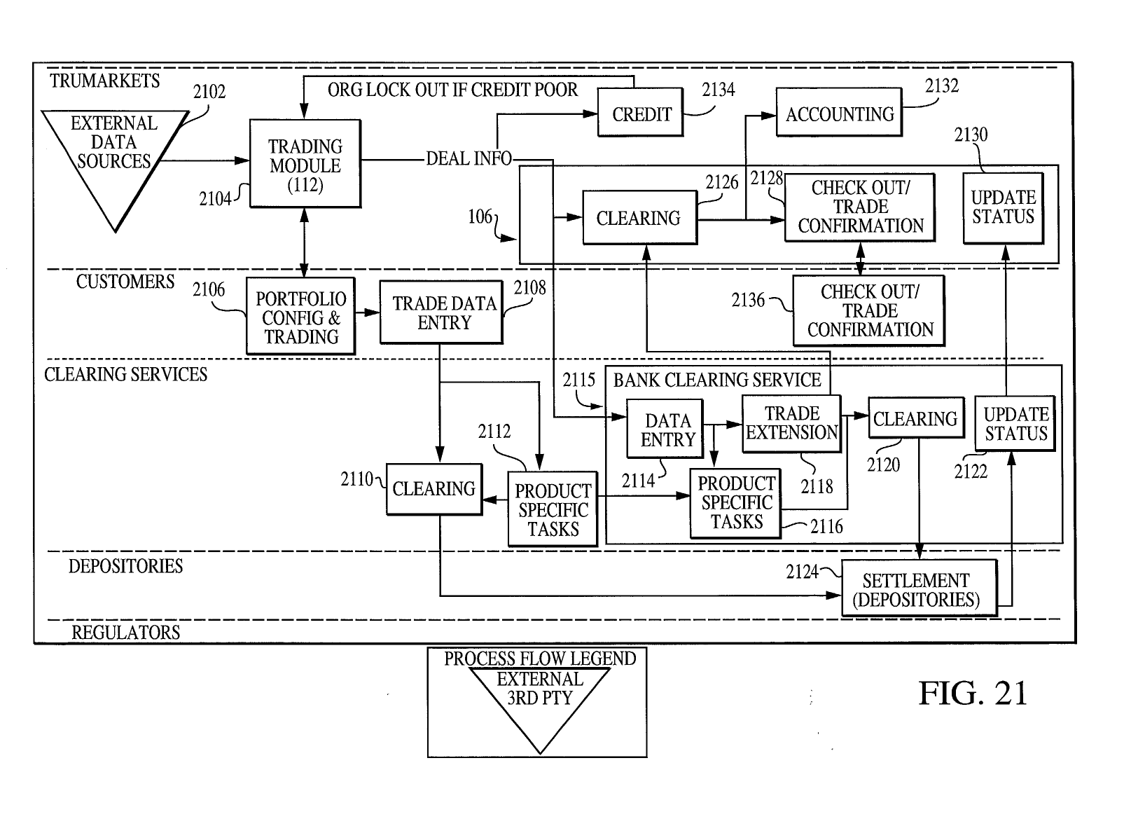

FIG. 21 is an exemplary flow diagram of the overall trading process. At 2102, pricing information is received 2104 at the pricing module 110 via data lines 104a-n, as discussed in regard to FIG. 1. Authorized traders can, as previously discussed, configure their portfolios and execute trades 2106. A credit check 2134 can optionally be performed for organizations (e.g., corporations) offering securities for trade 2108. Organizations that do not meet credit rating standards can optionally be precluded from offering securities to trading entities 102 via the trading module 112. Upon commencement of a trade, trade information can be sent 2110 to the clearing module 106. Trading entities 102 can also record clearing information pertaining to, for example, product specific tasks 2112 such as a To-Be-Annouced (TBA) settlement 2124. As will be recognized to those skilled in the art, to facilitate the allocation process of generic security transactions, the Public Securities Association (PSA) publishes monthly settlement dates for securities purchased in the TBA Market. Generally, within approximately 48 hours prior to settlement, the investor (i.e., trading entity 102 ) will be notified of the pools and the face amounts that will be delivered at settlement versus the purchase amount (in accordance with PSA guidelines for good delivery). The TBA information from block 2112, if applicable, can also be transmitted to, for example, a bank clearing service 2115, as indicated at block 2116. The trading module 112 can also send the bank clearing service 2115 trade related information, as indicated by block 2114. This information can also be combined with, for example, the information at block 2116 before it is transmitted to clearing 2120. The bank clearing services 2115 can also extend trade dates 2118, and update the status on existing and/or ongoing trades 2122. Data from clearing operations 2120 can also be sent to settlement 2124 (where the security or securities and funds are physically exchanged) which, in turn, can be provided to the bank clearing service 2115 to update trade status 2122.

Trade extension data 2118 can be sent 2126 to the clearing module 106, which can also verify trade information 2128 with the customer 2136, preferably before transmitting the trade information to accounting 2132. Additionally, the bank clearing service 2115 can update 2130 the clearing module 106, which feeds into the system 100 accounting software 2132.

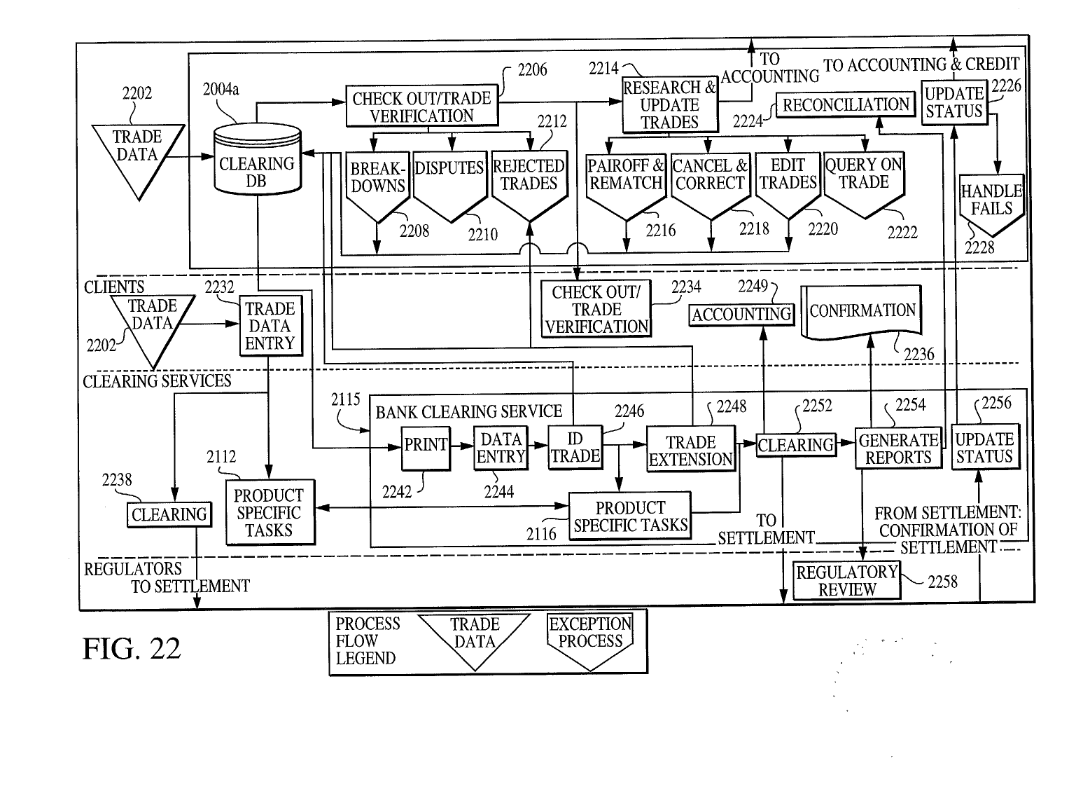

FIG. 22 is an exemplary flow diagram of exception processing within the clearing module 106. Client trade information 2202 from, for example, a client trading station 108a-n, can be transmitted from, for example, the trading module 112, to the clearing database 2004a. For a given trade, the trade data 2206 within the trading module 106 can be compared with the trade data 2234 within the trading entity 102 database 2004c. The clearing module 102 can check the data for breakdowns 2208 (i.e., the client can put the trade data into sub-accounts), disputes 2210 over, for example, price, quantity, date, etc.), and rejected trades 2212 (e.g., where a customer disputes that he/she has executed a particular trade). In the case of a breakdown 2208, the clearing database 2004a can be updated with the current customer sub-account information. The current customer sub-account information can also be transmitted to the bank clearing services.

After check out 2206, 2234, a user can perform research on trades and update trade information 2214 (e.g., pertaining to a client address and/or clearing bank, etc.), and or a trader identification changes A system 100 user can query a trade to determine whether a pairoff and rematch 2216 has occurred. As will be appreciated by those skilled in the art, a pairoff and rematch occurs when the same account buys and sells the same security on the same day. A system 100 user can also query a trade to determine whether a cancel and correct 2218 has occurred. As will be appreciated by those skilled in the art, a cancel and correct includes factor changes and partials/splits. A system 100 user can also edit trade information 2220. For example, missing address information, salesperson identification number, etc. can be added to the trade. Information pertaining to a pairoff and rematch 2216, a cancel and correct 2218, and a trade edit 2220 can be entered into the clearing database 2004a. Customers/users can also query trade information (e.g., buyer, seller, price, etc.) 2222.

Trade information 2202 can also be entered 2232 in, for example, a client database 2004d, cleared by the customer 2238, and sent to regulatory authorities. The customer can also process product specific tasks 2112 in conjunction with a bank clearing service 2116, as previously discussed. Trade data in the clearing database 2004a can be provided to a bank clearing service 2115 that can print 2242, enter the trade related data 2244, and assign a trade ID 2246. The trade ID can be provided to the clearing module database 2004a. If there are any trade extensions 2248 performed by the bank clearing service 2115, the original trade will now appear as a rejected trade 2212. The clearing database 2004a is preferably updated with the trade extension data. Bank clearing data 2252 can also be sent to regulatory authorities. After clearance 2252, reports 2254 can be generated and sent to the clearing module 106 for reconciliation 2224 (e.g., ensure that trades that are supposed to clear actually do clear, and that they clear only once) , customers 2236 for confirmation, and/or regulatory authorities 2258. Upon receipt of confirmation of settlement from regulatory authorities, the bank clearing service 2115 receives the update 2256, which can be subsequently transmitted to the clearing module 106 and any trading entities 108a-n involved in a trade 2226. Finally, the clearing module 106 can process any trades that fail to materialize (e.g., a party does not provide either cash or a security or securities at settlement), as indicated at block 2228.

### Computer Implementation

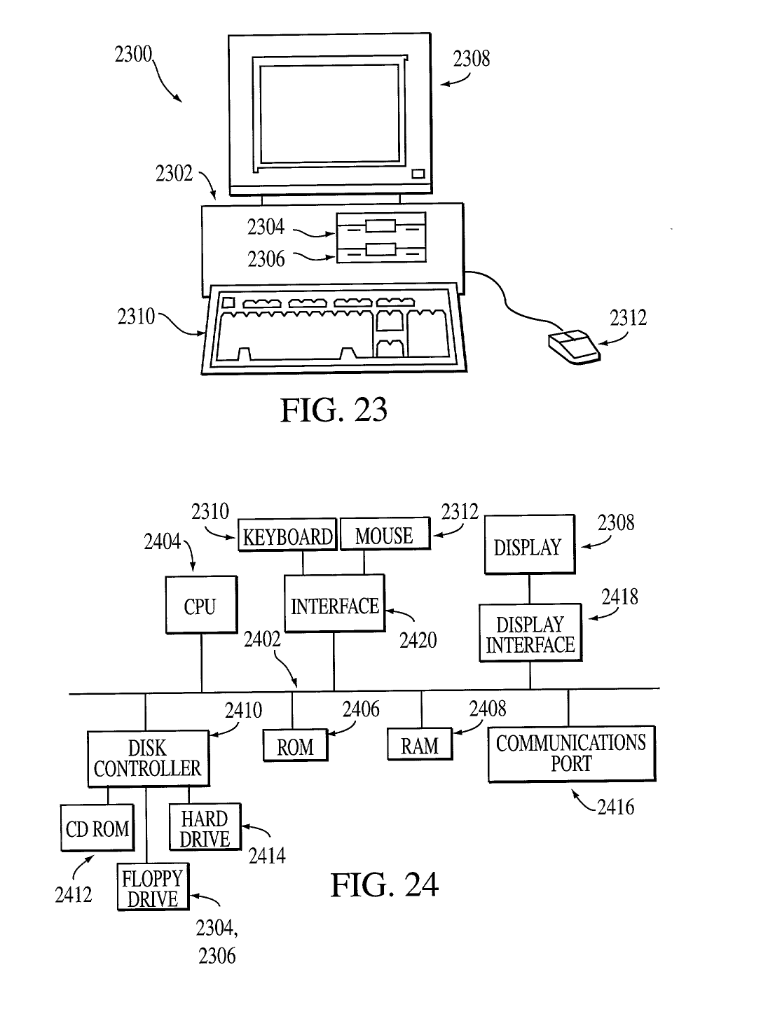

The techniques of the present invention may be implemented on a computing unit such as that depicted in FIG. 23. In this regard, FIG. 23 is an illustration of a computer system which is also capable of implementing some or all of the computer processing in accordance with computer implemented embodiments of the present invention. The procedures described herein are presented in terms of program procedures executed on, for example, a computer or network of computers.

Viewed externally in FIG. 23, a computer system designated by reference numeral 2300 has a computer portion 2302 having disk drives 2304 and 2306. Disk drive indications 2304 and 2306 are merely symbolic of a number of disk drives which might be accommodated by the computer system. Typically, these could include a floppy disk drive 2304, a hard disk drive (not shown externally) and a CD ROM indicated by slot 2306. The number and type of drives vary, typically with different computer configurations. Disk drives 2304 and 2306 are in fact optional, and for space considerations, are easily omitted from the computer system used in conjunction with the production process/apparatus described herein.

The computer system 2300 also has an optional display 2308 upon which information, such as the screens illustrated in, for example, FIGS. 3-5, etc. may be displayed. In some situations, a keyboard 2310 and a mouse 2312 are provided as input devices through which input may be provided, thus allowing input to interface with the central processing unit 2302. Then again, for enhanced portability, the keyboard 2310 is either a limited function keyboard or omitted in its entirety. In addition, mouse 2312 optionally is a touch pad control device, or a track ball device, or even omitted in its entirety as well, and similarly may be used as an input device. In addition, the computer system 2300 may also optionally include at least one infrared (or radio) transmitter and/or infrared (or radio) receiver for either transmitting and/or receiving infrared signals.

Although computer system 2300 is illustrated having a single processor, a single hard disk drive and a single local memory, the system 2300 is optionally suitably equipped with any multitude or combination of processors or storage devices. Computer system 2300 is, in point of fact, able to be replaced by, or combined with, any suitable processing system operative in accordance with the principles of the present invention, including hand-held, laptop/notebook, mini, mainframe and super computers, as well as processing system network combinations of the same.

FIG. 24 illustrates a block diagram of the internal hardware of the computer system 2300 of FIG. 23. A bus 2402 serves as the main information highway interconnecting the other components of the computer system 2300. CPU 2404 is the central processing unit of the system, performing calculations and logic operations required to execute a program. Read only memory (ROM) 2406 and random access memory (RAM) 2408 constitute the main memory of the computer 2302. Disk controller 2410 interfaces one or more disk drives to the system bus 2402. These disk drives are, for example, floppy disk drives such as 2304 or 2306, or CD ROM or DVD (digital video disks) drive such as 2412, or internal or external hard drives 2414. As indicated previously, these various disk drives and disk controllers are optional devices.

A display interface 2418 interfaces display 2408 and permits information from the bus 2402 to be displayed on the display 2308. Again as indicated, display 2308 is also an optional accessory. For example, display 2308 could be substituted or omitted. Communications with external devices, for example, the other components of the system described herein, occur utilizing communication port 2416. For example, optical fibers and/or electrical cables and/or conductors and/or optical communication (e.g., infrared, and the like) and/or wireless communication (e.g., radio frequency (RF), and the like) can be used as the transport medium between the external devices and communication port 2416. Peripheral interface 2420 interfaces the keyboard 2310 and the mouse 2312, permitting input data to be transmitted to the bus 2402.

In alternate embodiments, the above-identified CPU 2404, may be replaced by or combined with any other suitable processing circuits, including programmable logic devices, such as PALs (programmable array logic) and PLAs (programmable logic arrays). DSPs (digital signal processors), FPGAs (field programmable gate arrays), ASICs (application specific integrated circuits), VLSIs (very large scale integrated circuits) or the like.

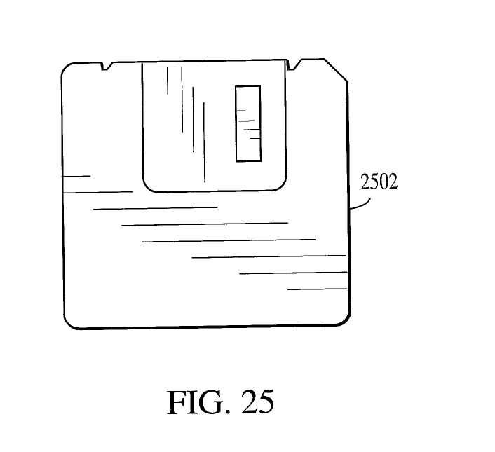

One of the implementations of the invention is as sets of instructions resident in the random access memory 2408 of one or more computer systems 2300 configured generally as described above. Until required by the computer system, the set of instructions may be stored in another computer readable memory, for example, in the hard disk drive 2414, or in a removable memory such as an optical disk for eventual use in the CD-ROM 2412 or in a floppy disk (e.g., floppy disk 2502 of FIG. 25) for eventual use in a floppy disk drive 2304, 2306. Further, the set of instructions (such as those written in the Java programming language) can be stored in the memory of another computer and transmitted via a transmission medium such as a local area network or a wide area network such as the Internet when desired by the user. One skilled in the art knows that storage or transmission of the computer program medium changes the medium electrically, magnetically, or chemically so that the medium carries computer readable information.

While the invention has been described in terms of a single preferred embodiment, those skilled in the art will recognize that the invention can be practiced with modification within the spirit and scope of the appended claims. For example, while the functionality of the invention has been described as being implemented primarily in software running on a general purpose computer, at least a portion of the functionality of the present invention could also easily be implemented by hardware or hardware/software combination.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what we claim as new and desire to secure by Letters Patent is as follows:

1. A computer-implemented fixed income security trading system that allows users to view, search, purchase and/or sell fixed income securities, comprising:
a) a plurality of trading entities that receive live market financial data pertaining to a plurality of fixed income securities offered for sale and/or purchase, and that enable users to i) search for securities in accordance with user specified search criteria, and/or ii) formulate at least one purchase offer for at least one of the securities, and/or iii) formulate a sale offer having sale offer criteria associated therewith for at least one security; and
b) a computer system receiving the purchase offers and that:
(i) searches sale offers for securities satisfying purchase offer criteria and executes a trade when purchase offer criteria are satisfied; and
(ii) precludes or temporarily and/or permanently removes a purchase offer and/or sale offer from trade eligibility as determined by at least one of the purchase offer criteria and sale offer criteria.

2. The system according to claim 1 wherein the plurality of trading entities receive the financial data from at least one financial data provider.

3. The system according to claim 1 wherein the search criteria comprise at least one of product type, coupon type, principal type, coupon, weighted average life, credit rating, weighted average coupon rate, weighted average collateral maturity, and collateral issue.

4. The system according to claim 1 wherein a trade is executed when a purchase offer price and a security sale price are equal.

5. The system according to claim 1 wherein a trade is executed when:
a) a purchase offer price is greater than a sell offer price;
b) a bid total amount available for matching (TAAM) is less than an offer TAAM; and
c) the bid TAAM equals an offer minimum plus a positive integer multiplier of an offer increment.

6. The system according to claim 1 wherein a trade is executed when:
a) a purchase offer price is greater than a sell offer price;
b) a bid total amount available for matching (TAAM) is less than an offer TAAM;
c) a bid minimum plus a bid increment times a first integer multiplier is equal to an offer minimum plus an offer increment times a second integer multiplier, the first and second integer multipliers being greater than zero;
d) the bid minimum plus the bid increment times the first integer multiplier is less than a bid TAAM; and
e) an offer minimum plus the offer increment times the second integer multiplier is less then the offer TAAM.

7. The system according to claim 1 wherein a trade is executed when:
a) a purchase offer price is greater than a sell offer price;
b) a bid total amount available for matching (TAAM) is greater than an offer TAAM; and
c) the offer TAAM is equal to a bid minimum plus a first positive integer multiplier times a bid increment.

8. The system according to claim 1 further comprising a clearing module that records at least a portion of the transaction data associated with executing and clearing a trade.

9. The system according to claim 8 wherein the transaction data comprises at least one of name of purchaser, name of seller, purchase/sale price, purchaser's clearing bank, seller's clearing bank, trade date, and settlement date.

10. The system according to claim 1 wherein the plurality of trading entities receive the financial data in a common format.

11. The system according to claim 1 wherein the plurality of trading entities convert the financial data into a common format.

12. The system according to claim 1 wherein the purchase offer criteria comprise at least one of product type, coupon type, principal type, coupon, weighted average life, credit rating, weighted average coupon rate, weighted average collateral maturity, and collateral issuer.

13. The system according to claim 1 wherein at least one of the purchase offer and the trade offer utilize a flat price.

14. The system according to claim 1 wherein at least one of the purchase offer and the sale offer utilize spread pricing.

15. The system according to claim 1 wherein at least one of the purchase offer and the sale offer utilize duration pricing.

16. The system according to claim 1 wherein a trading entity can simultaneously cancel all outstanding purchase offers and/or sale offers.

17. The system according to claim 1 wherein at least a portion of the purchase offers and sale offers together comprise an auction having a predetermined execution time at which trades are eligible for execution.

18. The system according to claim 17 wherein the purchase offers are available for all trading entities to view.

19. The system according to claim 17 wherein a purchase offer made by a trading entity is not viewable by other trading entities.

20. The system according to claim 17 wherein trading entities can view the best bid offer(s) and/or the best sell offer(s) for a given security.

21. A method of trading fixed income securities that allows users to view, search, purchase and/or sell fixed income securities, said method comprising the steps of:
a) receiving at a plurality of trading entities live market financial data pertaining to a plurality of fixed income securities offered for sale and/or purchase, the trading entities enabling users to i) search for securities in accordance with user specified search criteria, and/or ii) formulate at least one purchase offer for at least one of the securities, and/or iii) formulate a sale offer having sale offer criteria associated therewith for at least one security;
b) searching sale offers for securities satisfying purchase offer criteria, and executes a trade when purchase offer criteria are satisfied; and
c) precluding or temporarily and/or permanently removing a purchase offer and/or sale offer from trade eligibility as determined by at least one of the purchase offer criteria and sale offer criteria.

22. The method according to claim 21 wherein the plurality of trading entities receive the financial data from at least one financial data provider.

23. The method according to claim 21 wherein the search criteria comprise at least one of product type, coupon type, principal type, coupon, weighted average life, credit rating, weighted average coupon rate, weighted average collateral maturity, and collateral issue.

24. The method according to claim 21 wherein a trade is executed when a purchase offer price and a security sale price are equal.

25. The method according to claim 21 wherein a trade is executed when:
a) a purchase offer price is greater than a sell offer price;
b) a bid total amount available for matching (TAAM) is less than an offer TAAM; and
c) the bid TAAM equals an offer minimum plus a positive integer multiplier of an offer increment.

26. The method according to claim 21 wherein a trade is executed when:
a) a purchase offer price is greater than a sell offer price;
b) a bid total amount available for matching (TAAM) is less than an offer TAAM;
c) a bid minimum plus a bid increment times a first integer multiplier is equal to an offer minimum plus an offer increment times a second integer multiplier, the first and second integer multipliers being greater than zero;
d) the bid minimum plus the bid increment times the first integer multiplier is less than a bid TAAM; and
e) an offer minimum plus the offer increment times the second integer multiplier is less then the offer TAAM.

27. The method according to claim 21 wherein a trade is executed when:
a) a purchase offer price is greater than a sell offer price;
b) a bid total amount available for matching (TAAM) is greater than an offer TAAM; and
c) the auction TAAM is equal to a bid minimum plus a first positive integer multiplier times a bid increment.

28. The method according to claim 21 further comprising the step of storing at least a portion of the transaction data associated with executing and clearing a trade.

29. The method according to claim 28 wherein the transaction data comprises at least one of name of purchaser, name of seller, purchase/sale price, purchaser's clearing bank, seller's clearing bank, trade date, and settlement date.

30. The method according to claim 21 wherein the plurality of trading entities receive the financial data in a common format.

31. The method according to claim 21 wherein the plurality of trading entities convert the financial data into a common format.

32. The method according to claim 21 wherein the purchase offer criteria comprise at least one of product type, coupon type, principal type, coupon, weighted average life, credit rating, weighted average coupon rate, weighted average collateral maturity, and collateral issuer.

33. The method according to claim 21 wherein at least one of the purchase offer and the trade offer utilize a flat price.

34. The method according to claim 21 wherein at least one of the purchase offer and the sale offer utilize spread pricing.

35. The method according to claim 21 wherein at least one of the purchase offer and the sale offer utilize duration pricing.

36. The method according to claim 21 wherein a trading entity can simultaneously cancel all outstanding purchase offers and/or sale offers.

37. The method according to claim 21 wherein at least a portion of the purchase offers and sale offers together comprise an auction having a predetermined execution time at which trades are eligible for execution.

38. The method according to claim 37 wherein the purchase offers are available for all trading entities to view.

39. The method according to claim 37 wherein a purchase offer made by a trading entity is not viewable by other trading entities.

40. The method according to claim 37 wherein trading entities can view the best bid offer(s) and/or the best sell offer(s) for a given security.

41. A computer program medium storing computer instructions therein for instructing a computer to perform a computer-implemented and user assisted process for trading fixed income securities that allows users to view, search, purchase and/or sell fixed income securities, said program medium comprising:
a recording medium readable by the computer; and
the computer instructions stored on said recording medium instructing the computer to perform the computer-implemented and user assisted process, the instructions including:
a) receiving at a plurality of trading entities live market financial data pertaining to a plurality of fixed income securities offered for sale and/or purchase, the trading entities enabling users to i) search for securities in accordance with user specified search criteria and/or ii) formulate at least one purchase offer for at least one of the securities, and/or iii) formulate a sale offer for at least one security;
b) searching sale offers for securities satisfying purchase offer criteria, and executes a trade when purchase offer criteria are satisfied; and
c) precluding or temporarily and/or permanently removing a purchase offer and/or sale offer from trade eligibility as determined by at least one of the purchase offer criteria and sale offer criteria.

42. The computer program medium according to claim 41 wherein the plurality of trading entities receive the financial data from at least one financial data provider.

43. The computer program medium according to claim 41 wherein the search criteria comprise at least one of product type, coupon type, principal type, coupon, weighted average life, credit rating, weighted average coupon rate, weighted average collateral maturity, and collateral issue.

44. The computer program medium according to claim 41 wherein a trade is executed when a purchase offer price and a security sale price are equal.

45. The computer program medium according to claim 41 wherein a trade is executed when:
a) a purchase offer price is greater than a sell offer price;
b) a bid total amount available for matching (TAAM) is less than an offer TAAM; and
c) the bid TAAM equals an offer minimum plus a positive integer multiplier of an offer increment.

46. The computer program medium according to claim 41 wherein a trade is executed when:
a) a purchase offer price is greater than a sell offer price;
b) a bid total amount available for matching (TAAM) is less than an offer TAAM;
c) a bid minimum plus a bid increment times a first integer multiplier is equal to an offer minimum plus an offer increment times a second integer multiplier, the first and second integer multipliers being greater than zero;
d) the bid minimum plus the bid increment times the first integer multiplier is less than a bid TAAM; and
e) an offer minimum plus the offer increment times the second integer multiplier is less then the offer TAAM.

47. The computer program medium according to claim 41 wherein a trade is executed when:
a) a purchase offer price is greater than a sell offer price;
b) a bid total amount available for matching (TAAM) is greater than an offer TAAM; and
c) the offer TAAM is equal to a bid minimum plus a first positive integer multiplier times a bid increment.

48. The computer program medium according to claim 41 further comprising the step of storing at least a portion of the transaction data associated with executing and clearing a trade.

49. The computer program medium according to claim 48 wherein the transaction data comprises at least one of name of purchaser, name of seller, purchase/sale price, purchaser's clearing bank, seller's clearing bank, trade date, and settlement date.

50. The computer program medium according to claim 41 wherein the plurality of trading entities receive the financial data in a common format.

51. The computer program medium according to claim 41 wherein the plurality of trading entities convert the financial data into a common format.

52. The computer program medium according to claim 41 wherein the purchase offer criteria comprise at least one of product type, coupon type, principal type, coupon, weighted average life, credit rating, weighted average coupon rate, weighted average collateral maturity, and collateral issuer.

53. The computer program medium according to claim 41 wherein at least one of the purchase offer and the trade offer utilize a flat price.

54. The computer program medium according to claim 41 wherein at least one of the purchase offer and the sale offer utilize spread pricing.

55. The computer program medium according to claim 41 wherein at least one of the purchase offer and the sale offer utilize duration pricing.

56. The computer program medium according to claim 41 wherein a trading entity can simultaneously cancel all outstanding purchase offers and/or sale offers.

57. The computer program medium according to claim 41 wherein at least a portion of the purchase offers and sale offers together comprise an auction having a predetermined execution time at which trades are eligible for execution.

58. The computer program medium according to claim 57 wherein the purchase offers are available for all trading entities to view.

59. The computer program medium according to claim 57 wherein a purchase offer made by a trading entity is not viewable by other trading entities.

60. The computer program medium according to claim 57 wherein trading entities can view the best bid offer(s) and/or the best sell offer(s) for a given security.

61. A computer-implemented fixed income security trading system that allows users to view, search, purchase and/or sell fixed income securities, comprising:
a) a plurality of trading entities that receive live market financial data pertaining to a plurality of fixed income securities for sale and/or purchase, and that enable users to i) search for securities in accordance with user specified search criteria, and/or ii) formulate at least one purchase offer for at least one of the securities, and/or iii) formulate a sale offer having sale offer criteria associated therewith for at least one security; and
b) a computer system receiving the purchase offers and that:
(i) searches sale offers for securities satisfying purchase offer criteria and executes a trade without revealing the actual identity of at least one of the purchaser and seller when purchase offer criteria are satisfied; and
(ii) precludes or temporarily and/or permanently removes a purchase offer and/or sale offer from trade eligibility as determined by at least one of the purchase offer criteria and sale offer criteria.

62. A method of trading fixed income securities that allows users to view, search, purchase and/or sell fixed income securities, said method comprising the steps of:
a) receiving at a plurality of trading entities live market financial data pertaining to a plurality of fixed income securities offered for sale and/or purchase, the trading entities enabling users to i) search for securities in accordance with user specified search criteria, and/or ii) formulate at least one purchase offer for at least one of the securities, and/or iii) formulate a sale offer having sale offer criteria associated therewith for at least one security;
b) searching sale offers for securities satisfying purchase offer criteria, and executes a trade without revealing the actual identity of at least one of the purchaser and seller when purchase offer criteria are satisfied; and
c) precluding or temporarily and/or permanently removing a purchase offer and/or sale offer from trade eligibility as determined by at least one of the purchase offer criteria and sale offer criteria.

63. A computer program medium storing computer instructions therein for instructing a computer to perform a computer-implemented and user assisted process for trading fixed income securities that allows users to view, search, purchase and/or sell fixed income securities, said program medium comprising:
a recording medium readable by the computer; and
the computer instructions stored on said recording medium instructing the computer to perform the computer-implemented and user assisted process, the instructions including:
a) receiving at a plurality of trading entities live market financial data pertaining to a plurality of fixed income securities for offered for sale and/or purchase, the trading entities enabling users to i) search for securities in accordance with user specified search criteria and/or ii) formulate at least one purchase offer for at least one of the securities, and/or iii) formulate a sale offer for at least one security;
b) searching sale offers for securities satisfying purchase offer criteria, and executes a trade without revealing the actual identity of at least one of the purchaser and seller when purchase offer criteria are satisfied; and
c) precluding or temporarily and/or permanently removing a purchase offer and/or sale offer from trade eligibility as determined by at least one of the purchase offer criteria and sale offer criteria.

64. A computer-implemented fixed income security trading system that allows users to view, search, purchase and/or sell fixed income securities, comprising:
a) a plurality of trading entities that receive live market financial data pertaining to a plurality of fixed income securities offered for sale and/or purchase, and that enable users, without revealing their actual identity, to i) search for securities in accordance with user specified search criteria, and/or ii) formulate at least one purchase offer for at least one of the securities, and/or iii) formulate a sale offer having sale offer criteria associated therewith for at least one security; and;
b) a computer system receiving the purchase offers and that searches sale offers for securities satisfying purchase offer criteria and executes a trade when purchase offer criteria are satisfied; and
c) a clearing module that records at least a portion of the transaction data associated with executing and clearing a trade.

65. A method of trading fixed income securities that allows users to view, search, purchase and/or sell fixed income securities, said method comprising the steps of:
a) receiving at a plurality of trading entities live market financial data pertaining to a plurality of fixed income securities offered for sale and/or purchase, the trading entities enabling users to i) search for securities in accordance with user specified search criteria, and/or ii) formulate at least one purchase offer for at least one of the securities, and/or iii) formulate a sale offer having sale offer criteria associated therewith for at least one security;
b) searching sale offers for securities satisfying purchase offer criteria, and executes a trade without revealing the actual identity of at least one of the purchaser and seller when purchase offer criteria are satisfied; and
c) recording at least a portion of the transaction data associated with executing and clearing a trade.

66. A computer program medium storing computer instructions therein for instructing a computer to perform a computer-implemented and user assisted process for trading fixed income securities that allows users to view, search, purchase and/or sell fixed income securities, said program medium comprising:
a recording medium readable by the computer; and
the computer instructions stored on said recording medium instructing the computer to perform the computer-implemented and user assisted process, the instructions including:
a) receiving at a plurality of trading entities live market financial data pertaining to a plurality of fixed income securities offered for sale and/or purchase, the trading entities enabling users to i) search for securities in accordance with user specified search criteria and/or ii) formulate at least one purchase offer for at least one of the securities, and/or iii) formulate a sale offer for at least one security;
b) searching sale offers for securities satisfying purchase offer criteria, and executes a trade without revealing the actual identity of at least one of the purchaser and seller when purchase offer criteria are satisfied; and
c) recording at least a portion of the transaction data associated with executing and clearing a trade.

67. A computer-implemented fixed income security trading system that allows users to view, search, purchase and/or sell fixed income securities, comprising:
a) a plurality of trading entities that receive live market financial data pertaining to a plurality of fixed income securities offered for sale and/or purchase, and that enable users, without revealing their actual identity, to i) search for securities in accordance with user specified search criteria, and/or ii) formulate at least one purchase offer for at least one of the securities, and/or iii) formulate a sale offer having sale offer criteria associated therewith for at least one security; and;
b) a computer system receiving the purchase offers and that searches sale offers for securities satisfying purchase offer criteria and executes a trade when purchase offer criteria are satisfied; and
c) a clearing module that records at least a portion of the transaction data associated with executing and clearing a trade, and transmits at least a portion of the transaction data to at least one of a trading entity and a financial institution that performs a clearing operation associated with the trade.

68. A computer-implemented fixed income security trading system that allows users to view, search, purchase and/or sell fixed income securities, comprising:
a) a plurality of trading entities that receive live market financial data pertaining to a plurality of fixed income securities offered for sale and/or purchase, and that enable users, without revealing their actual identity, to i) search for securities in accordance with user specified search criteria, and/or ii) formulate at least one purchase offer for at least one of the securities, and/or iii) formulate a sale offer having sale offer criteria associated therewith for at least one security; and/or iv) purchase and or sell a security based upon at least one purchase offer and one sale offer;
b) a computer system receiving the purchase offers and that searches sale offers for securities satisfying purchase offer criteria and executes a trade when purchase offer criteria are satisfied; and
c) a clearing module that records at least a portion of the transaction data associated with executing and clearing a trade, and transmits at least a portion of the transaction data to at least one of a trading entity and a financial institution that performs a clearing operation associated with the trade.

69. A computer program medium storing computer instructions therein for instructing a computer to perform a computer-implemented and user assisted process for trading fixed income securities that allows users to view, search, purchase and/or sell fixed income securities, said program medium comprising:
a recording medium readable by the computer; and
the computer instructions stored on said recording medium instructing the computer to perform the computer-implemented and user assisted process, the instructions including:
a) receiving at a plurality of trading entities live market financial data pertaining to a plurality of fixed income securities offered for sale and/or purchase, the trading entities enabling users to i) search for securities in accordance with user specified search criteria and/or ii) formulate at least one purchase offer for at least one of the securities, and/or iii) formulate a sale offer for at least one security;
b) searching sale offers for securities satisfying purchase offer criteria, and executes a trade without revealing the actual identity of at least one of the purchaser and seller when purchase offer criteria are satisfied; and
c) a clearing module that records at least a portion of the transaction data associated with executing and clearing a trade, and transmits at least a portion of the transaction data to at least one of a trading entity and a financial institution that performs a clearing operation associated with the trade.
